(19) United States
(12) Patent Application Publication
(10) Pub. No.: US 2013/0204657 A1
(43) Pub. Date: Aug. 8, 2013

(54) FILTERING REDUNDANT CONSUMER TRANSACTION RULES

(71) Applicants: Partha Pratim Ghosh, Hyderabad (IN); Nagendra Kumar, Hyderabad (IN); Hrushikesh Bokil, Hyderabad (IN)

(72) Inventors: Partha Pratim Ghosh, Hyderabad (IN); Nagendra Kumar, Hyderabad (IN); Hrushikesh Bokil, Hyderabad (IN)

(73) Assignee: Microsoft Corporation, Redmond, WA (US)

(21) Appl. No.: 13/366,161

(22) Filed: Feb. 3, 2012

(51) Int. Cl. G06Q 30/02

(52) U.S. Cl. 705/7.29

(57) ABSTRACT

Redundancy filtering for consumer transaction rules can be achieved via a variety of techniques. A support band can be used to cluster rules during redundancy analysis. Bit vectors can be used to identify redundant rules. Other features, such as anyfication can be used to advantage. Various benchmarks can be used to demonstrate improved performance.

### BACKGROUND

With the widespread use of mobile computing, consumers engage in an ever-increasing number of transactions, such as trying and buying new applications. However, the sheer number of consumers combined with the vast number of offerings can make marketing a challenging task in the mobile computing world.

Various tools, including search technologies, have been implemented to help consumers find applications. However, less attention has been given to helping application developers find consumers. For example, a developer may be given information regarding the number of application purchases. While a simple number can give some indication of whether marketing efforts have been successful, there remains room for improvement.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Consumer transaction rules can indicate characteristics of consumers participating in various application store transactions. Redundant consumer transaction rules can be filtered to remove superfluous information. Meaningful information about consumer characteristics can be presented in a limited amount of space.

Redundancy identification can employ a variety of techniques, such as determining that support ratings are sufficiently close. For example, a threshold ε can be used to cluster rules into support bands for redundancy filtering.

Other techniques include identifying containment relationships in a variety of ways, such as via the bit vector techniques described herein.

Various other features, such as anyfication of rule entries can be used to advantage.

Redundancy filtering results in fewer rules conveying the same or more information, which can be particularly useful in user interfaces depicting the consumer transaction rules and other scenarios.

As described herein, a variety of other features and advantages can be incorporated into the technologies as desired.

### BRIEF DESCRIPTION OF THE DRAWINGS

FIG. 1 is a block diagram of an exemplary system implementing filtering of redundant consumer transaction rules.

FIG. 2 is a flowchart of an exemplary method of filtering redundant consumer transaction rules.

FIG. 3 is a block diagram showing basic redundant consumer transaction rule filtering.

FIG. 4 is a block diagram of an exemplary set of consumer transaction rule entries.

FIG. 5 is a screen shot of an exemplary user interface for a development miner tool that includes consumer transaction rules filtered to remove redundancy.

FIG. 6 is a block diagram of an exemplary system implementing filtering of redundant consumer transaction rules with a support band tool.

FIG. 7 is a flowchart of an exemplary method implementing filtering of redundant consumer transaction rules via support bands.

FIG. 8 is a block diagram of an exemplary system implementing filtering of redundant consumer transaction rules with a bit vector tool.

FIG. 9 is a flowchart of an exemplary method implementing filtering of redundant consumer transaction rules via bit vectors.

FIG. 10 is a table showing exemplary consumer transaction rules.

FIG. 11 is a table showing exemplary consumer transaction rules with anyfication applied.

FIG. 12 is a table showing redundancy filtering via bit vector.

FIG. 13 is another table showing redundancy filtering via bit vector.

FIG. 14 is a block diagram showing performance metrics for redundancy filtering.

FIG. 15 is a block diagram showing application of a nearest neighbor technique to achieve redundancy filtering.

FIG. 16 is a block diagram of an exemplary architecture for achieving redundancy filtering.

FIGS. 17, 18, 19, and 20 are graphs showing data set performance.

FIG. 21 is a diagram of an exemplary computing system in which some described embodiments can be implemented.

FIG. 22 is an exemplary mobile device that can be used for engaging in consumer transactions in an application store.

FIG. 23 is an exemplary cloud-support environment that can be used in conjunction with the technologies described herein.

### DETAILED DESCRIPTION

### Example 1

### Exemplary Overview

The technologies described herein can be used for a variety of redundancy filtering scenarios. Adoption of the technologies can provide efficient techniques for filtering redundant rules.

The technologies can be helpful for those wishing to monitor the characteristics of consumers involved in application store transactions. Beneficiaries include application developers, who wish to determine the characteristics of current and likely future consumers. Consumers can also indirectly benefit from the technologies because they are more likely to be correctly recognized as being possibly interested in a particular application.

### Example 2

### Exemplary System Implementing Filtering Redundant Transaction Rules

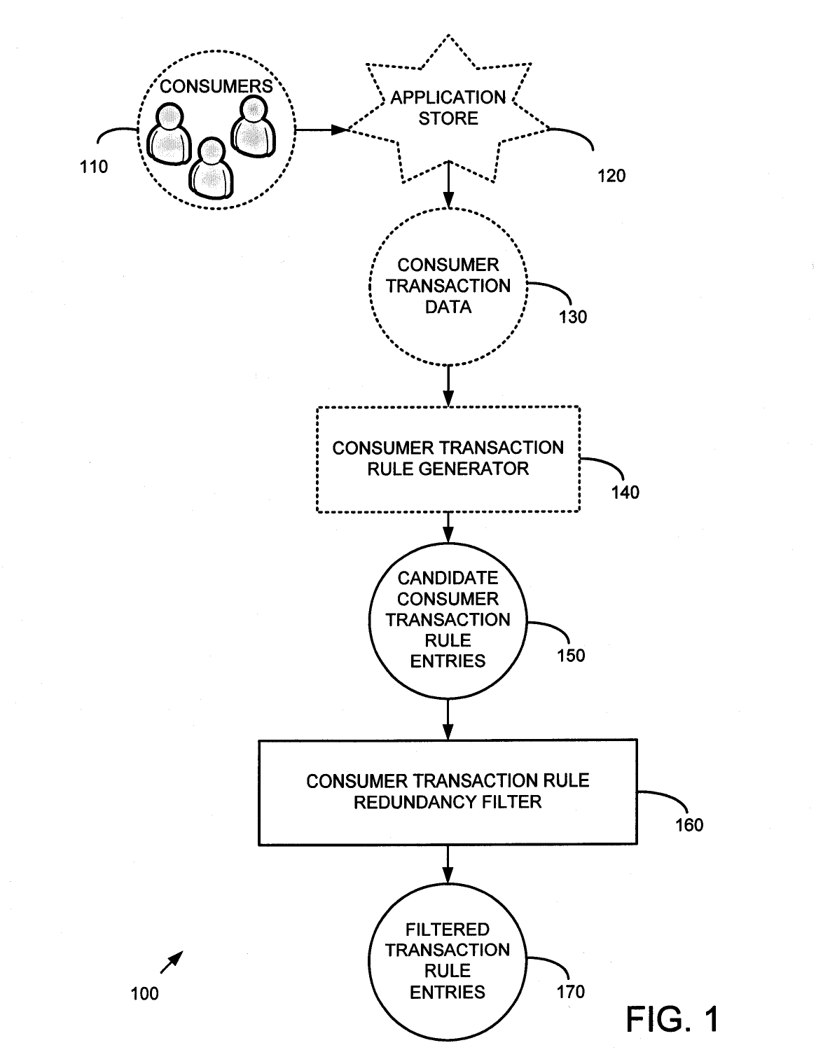

FIG. 1 is a block diagram of an exemplary system 100 implementing filtering of redundant consumer transaction rules described herein.

For purposes of context, the diagram shows an application store 120 that is accessed by consumers 110 to engage in consumer transactions involving various applications. Various aspects of the consumer transactions can be stored as consumer transaction data 130. A consumer transaction rule generator 140 can use any number of techniques to generate candidate consumer transaction rule entries 150 based on the consumer transaction data 130. For example, association rule (AR) generation techniques can be used.

In accordance with the technologies described herein, a consumer transaction rule redundancy filter 160 can apply any of the techniques described herein to filter the candidate consumer transaction rule entries 150 to generate filtered transaction rule entries 170.

In practice, the systems shown herein, such as system 100 can be more complicated, with additional functionality, more complex inputs, and the like.

The system 100 and any of the other systems described herein can be implemented in conjunction with any of the hardware components described herein, such as the computing systems described below (e.g., processing units, memory, and the like). In any of the examples herein, the inputs, outputs, and tools can be stored in one or more computer-readable storage media or computer-readable storage devices. The technologies described herein can be generic to the specifics of operating systems or hardware and can be applied in any variety of environments to take advantage of the described features.

### Example 3

### Exemplary Method Implementing Filtering Redundant Transaction Rules

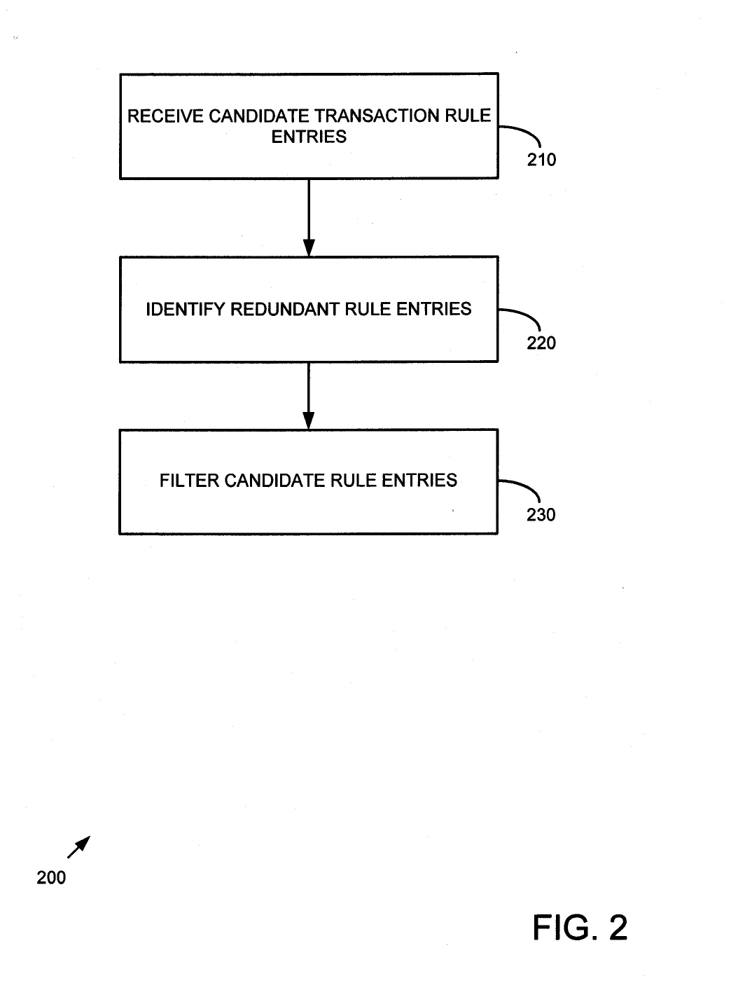

FIG. 2 is a flowchart of an exemplary method 200 of filtering redundant consumer transaction rules and can be implemented, for example, in the system shown in FIG. 1.

At 210, candidate transaction rule entries are received. As described herein, candidate consumer transaction rule entries can comprise rules indicating respective support ratings for occurrences of like consumer characteristic values associated with application store consumer transactions.

At 220, redundant rule entries are identified. As described herein, identifying rule entries as redundant can comprise determining that support ratings for two candidate consumer transaction rule entries are sufficiently close. Identifying can also comprise identifying a containment relationship between two candidate consumer transaction rule entries (e.g., directly or indirectly as described herein).

At 230, the candidate transaction rule entries are filtered (e.g., the redundant rule entries are removed).

The method 200 and any of the other methods described herein can be performed by computer-executable instructions (e.g., causing a computing system to perform the method) stored in one or more computer-readable media (e.g., storage or other tangible media) or stored in one or more computer-readable storage devices.

### Example 4

### Exemplary Redundant Consumer Transaction Rule Filtering

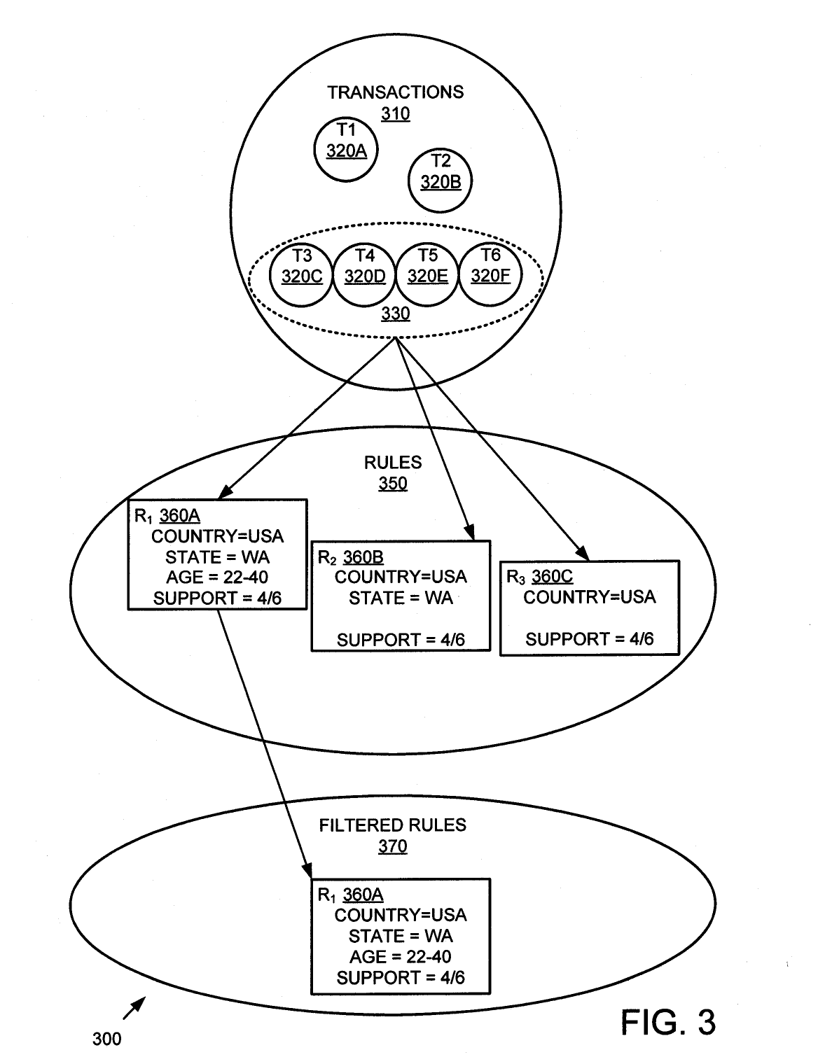

FIG. 3 is a block diagram showing basic redundant consumer transaction rule filtering.

In practice, the transactions 310 need not be directly accessible or a part of a redundancy filtering system. However, they are shown here for purposes of context.

The candidate rules 350 can be represented by rule entries 360A, 360B, 360C indicating respective support ratings for occurrences of like consumer characteristic values associated with application store consumer transactions 320A-F.

For example, in the example, four transactions 320C-F have like (e.g., the same) consumer characteristic values: Country=“USA”; State=“WA”; and Age=“22-40” because consumers engaged in the transactions have such characteristics. As a result, a rule generator (e.g., using association rule generation techniques), can generate various rules 360A-C supported by the transactions 320C-F. In the example, three rules 360A-C are generated. The support values for the rules are the same because they are based on the same rules. In practice, the rules 350 need not be strictly based on observed transactions, but can be constructed using statistical techniques such as sampling to reliably represent the actual transactions 310.

Evaluation of the rules 360A-C reveals that they have a containment relationship. The rules 360B and 360C are redundant with respect to the rule 360A because they convey less information (e.g., they have the same support and indicate only a subset of the attribute-value assertions of 360A).

Redundancy filtering as described herein can remove the two rules 360B-C, resulting in the filtered rules 370, which has only rule 360A. In practice, additional rules can be present (e.g., supported by transactions 320A, 320B, and the like).

### Example 5

### Exemplary Redundant Consumer Transaction Rules

In any of the examples herein, a redundant consumer transaction rule can be a rule that offers superfluous information with respect to another rule. In practice, the redundant rule offers less information than another rule and can therefore be filtered without significant loss of information in the resulting remaining rules. Redundant rules can be identified by determining a containment relationship exists between the rules and whether their support ratings are sufficiently close.

For example, in the example of FIG. 3, a population of six consumer application store transactions, four transactions for four different consumers can have attribute-values of “Country=USA,” “State=WA,” and “Age=22-40.” In such a case, a consumer transaction rule can indicate “Country=USA,” State=WA,” and “Age=22-40” with support of 0.67. Another rule can indicate “Country=USA” and “State=WA” with support of 0.67. Still another rule can indicate “Country=USA” with support of 0.67. The first rule is the most specific. The second two rules can be considered redundant because they are less specific than (e.g., provide less information by having fewer attribute-values pairs) the first rule and provide no additional information about the transactions beyond the first rule. In the example, they have identical support. However, in some other examples herein, support can be sufficiently close without being identical.

In practice, filtering the redundant rules allows fewer rules to be presented without significant loss of information, which can be helpful when presenting the rules for consideration by a user.

### Example 6

### Exemplary Consumer Transaction Rule Support

In any of the examples, a rule can have a support rating (or simply “support”) that indicates the number of transactions by consumers having characteristics fulfilling the rule. The support rating can be given in a variety of formats, such as an absolute number (e.g., 143 transactions), a ratio (e.g., 143 transactions matching the rule/1394 total transactions), a percentage (e.g., 10.3%), or the like. For example, for a pattern, P, support (P)=Freq(P)/Total.

### Example 7

### Exemplary Containment Relationship

In any of the examples herein, determining redundancy can include determining whether two rules have a containment relationship (e.g., consumer transactions fulfilling one rule are conclusively contained by the other). A rule that logically contains (or simply “contains”) the complete transactions of another rule (e.g., the rule specifies “any” where another rule specifies a particular value), can be eliminated as redundant, depending on support as described herein.

A first, more general, rule is said to contain a second, more specific, rule (e.g., the first rule specifies “any” where the second rule specifies a particular value). The more general rule can be removed as redundant, depending on support.

Rules having a set-subset relationship for their transaction population are said to have a “containment” relationship (e.g., the transactions for another rule are necessarily contained within another, more specific, rule). A logical set-subset relationship can exist even though transactions fulfilling the two rules are identical. As described herein, bit vectors can be used to determine whether a containment relationship exists.

### Example 8

### Exemplary Sufficiently Close Support Ratings

In any of the examples herein, sufficiently close support ratings can be indicated when support ratings are identical. However, non-identical support ratings can also be sufficiently close.

Examples described herein include using a support threshold c, extended support bands, clustering by support rating, and the like.

### Example 9

### Exemplary Consumer Transactions

In any of the examples herein, consumer transactions can take the form of consumer transactions involving a particular application (e.g., a downloadable program). For example, such transactions can include trying an application, downloading an application, buying an application, uninstalling an application, upgrading an application, or the like. If desired, transactions can include interactions with the application, such as using particular features of an application.

In practice, an application consumer can engage in such transactions via an application store and by interacting with the applications obtained therefrom. The application store can provide a rich environment by which a consumer can find, try, and download applications.

### Example 10

### Exemplary Consumer Transactions Types

Consumer transactions can be associated with a particular type to indicate what kind of transaction is involved. For example, exemplary transaction types include “buy,” “try,” “download,” “browse,” “uninstall,” and the like.

The rule filtering technologies described herein can be applied to transactions of a particular type, combinations of transactions of different types, or the like.

### Example 11

### Exemplary Consumer Characteristics

In any of the examples herein, a consumer transaction can be associated with characteristics (e.g., attributes) of the consumer.

Consumers can register with the application store, and the registration process can include collecting various consumer characteristics (e.g., demographic information) from the consumer and various information about the user's device. Privacy concerns can be addressed by sufficiently protecting a user's identity (e.g., not storing information specifically or personally identifying a consumer when analyzing the transactions).

### Example 12

### Exemplary Consumer Transaction Rules

In any of the examples herein, transaction rules can take the form of a set of attribute-value pairs indicating particular sets of attribute-value assertions that have been observed as associated with consumers engaging in consumer transactions (e.g., via an application store). For example, the characteristics of consumers engaged in consumer transactions can be used to form the consumer transaction rules. Transactions satisfying the rule are said to support the rule. Typically, rules of interest are those involving greater support (e.g., a large number of consumers have characteristics that meet the rule). However, sometimes a rule of lesser support can be of interest.

In practice, the rules can be used to designate consumer transaction demographic patterns (e.g., sets of consumer characteristics that occur with frequency within consumer transaction data).

As described herein, a rule can be stored as a rule entry having a set of attribute-value pairs (e.g., an attribute-value assertion or “AVA”) indicating the demographics represented by the rule (e.g., a rule entry can have attribute-value pairs “attribute₁=value₁” “attribute₂=value₂” and the like). In practice, the pairs can be stored as XML, structured data, fields in a database, or the like.

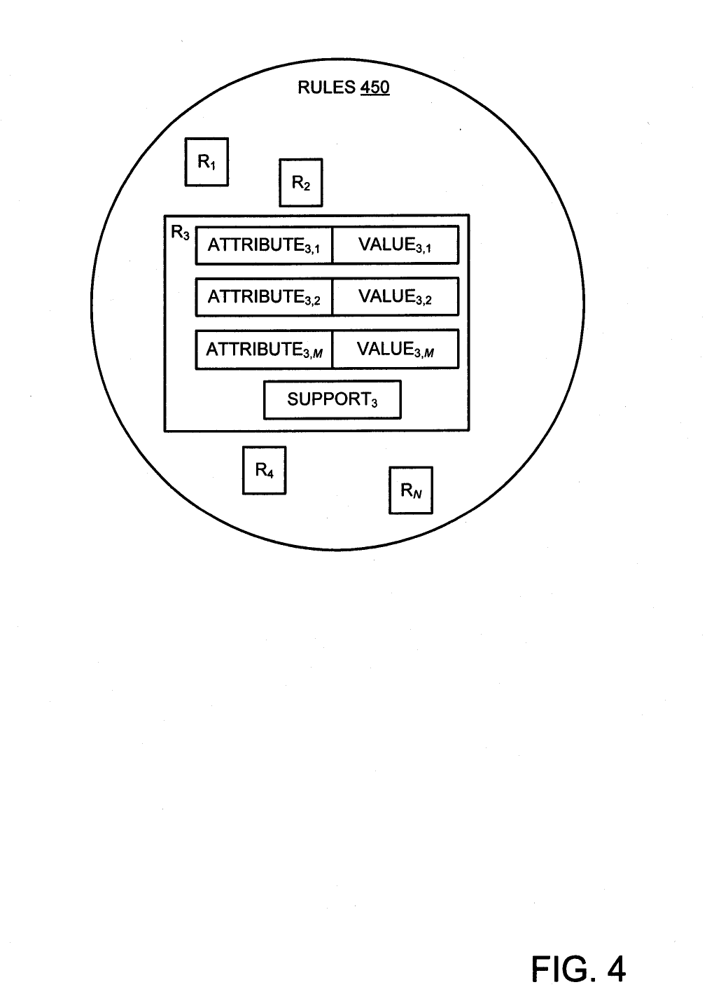

FIG. 4 is a block diagram of an exemplary set of consumer transaction rule entries 450. In practice, hundreds, thousands, or more rules can be generated from analysis of transactions. Filtering as described herein can make the rules more intelligible to developers who seek to know more about their customers.

### Example 13

### Exemplary Internal Representations

In practice, values, attributes, rules, and the like can be internally represented in a variety of ways. For example, a particular value (e.g., the country “USA”) can be represented by a code (e.g., numeric or the like) instead of a literal value or string. However, when rendered for consideration by a user, human understandable values can be shown.

### Example 14

### Exemplary Domain-Specific Heuristics

In any of the examples herein, consumer transaction rule entries can be refined based on domain-specific heuristics. For example, in the case of consumer characteristics, if it is known that one value implies another, the value can be supplied during refinement.

An example of such a domain-specific heuristic is detecting that a state has been supplied without a country. If the state is known to be part of the geography of a country, the country can be added to the rule responsive to detecting that the state is present in the rule. For example, if the state of Washington (“WA”) is present in a rule, but the country is missing, the country United States (“USA”) can be added to the rule (e.g., country=“USA”).

### Example 15

### Exemplary User Interface Presenting Filtered Rules

In any of the examples herein, filtering the candidate transaction rule entries can generate filtered rule entries. The filtered rule entries can then be displayed in a user interface.

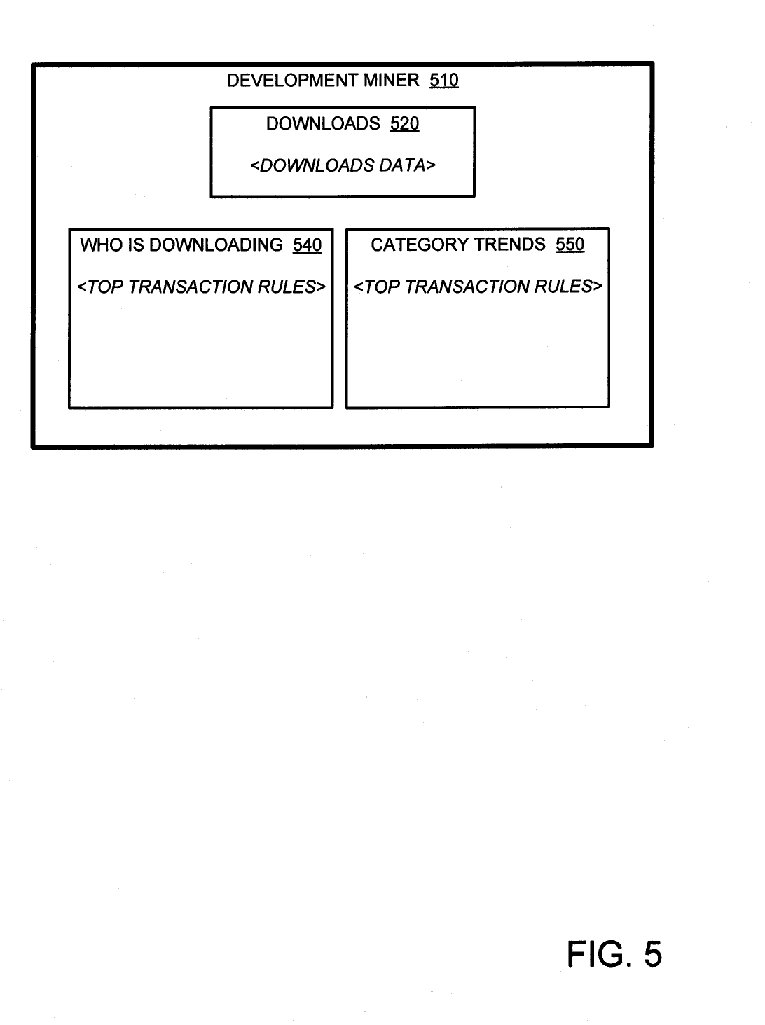

FIG. 5 is a screen shot of an exemplary user interface 510 for a development miner tool that includes consumer transaction rules filtered to remove redundancy. The user interface can improve optimizing user experience while displaying the consumer transaction rules by applying the filtering technologies described herein.

In the example, the tool 510 includes a downloads data pane 520 (e.g., the number of downloads of an application).

A user interface can also include a who is downloading pane 540 (e.g., showing the top A filtered consumer transactions rules, ranked by support rating), and category trends pane 550 (e.g., showing the top n filtered consumer transaction rules for other applications in the same category as the application, ranked by support rating).

The pane 540 can display the top n filtered application store consumer transaction rules. The application store consumer transaction rules can indicate consumer characteristic values associated with application store consumer transactions associated with the application store consumer transaction rules. The filtered application store consumer transaction rules can be filtered according to a support threshold ε and containment relationships as described herein. The filtered application store consumer transaction rules can be sorted by support rating (e.g., highest to lowest, in descending order).

In practice, any number of other configurations is possible. The redundancy filtering technology described herein can be used in a wide variety of scenarios in which screen real estate is limited to display more meaningful information about application store consumers.

### Example 16

### Exemplary System Filtering Via Support Bands

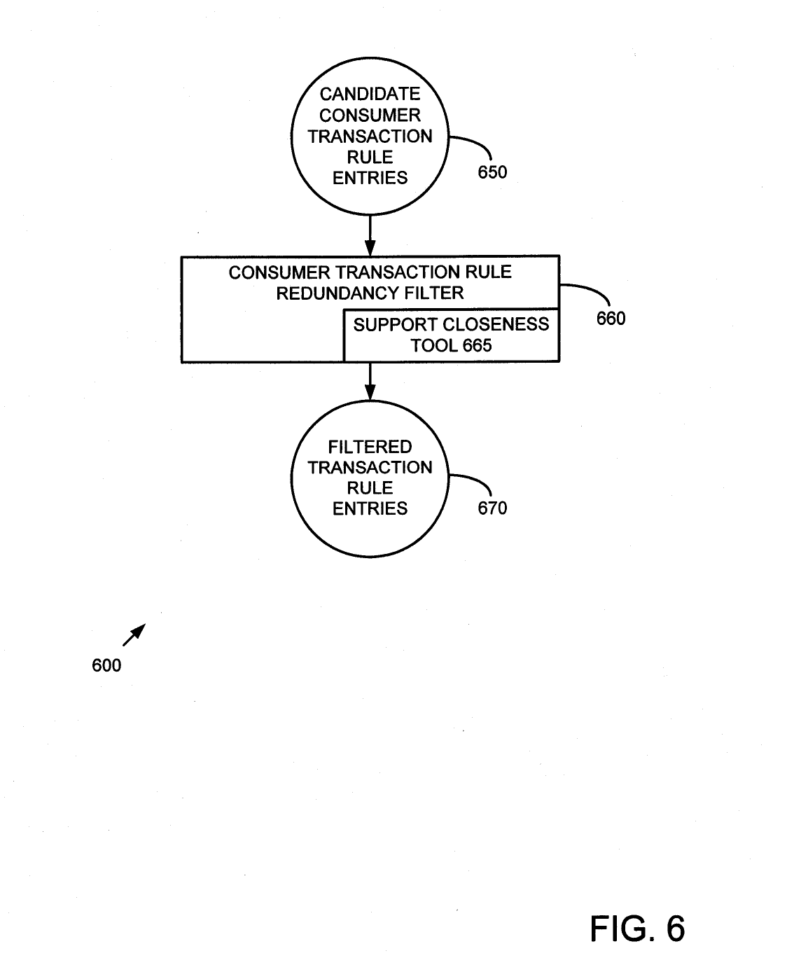

FIG. 6 is a block diagram of an exemplary system 600 implementing filtering of redundant consumer transaction rules with a support closeness tool 665.

In the example, the candidate consumer transaction rule entries 650 and the filtered transaction rule entries 670 can take the form of rule entries as described elsewhere herein.

The redundancy filter 660 includes a support closeness tool 665, which can use any of the techniques herein to determine whether the support ratings of two rules are sufficiently close to be considered redundant (e.g., if they also have a containment relationship). For example, a threshold ε can be used to extend support bands beyond simple identical support. Various other techniques are described herein.

Because the candidate consumer transaction rule entries 650 can be derived from a large number of transactions and may rely on statistical techniques, there exists the possibility that support ratings for the rule entries will contain noise. Accordingly, allowing redundancy filtering in the case where two rules do not have identical support can be of great advantage to removing superfluous rule entries.

### Example 17

### Exemplary Method Filtering Via Support Bands

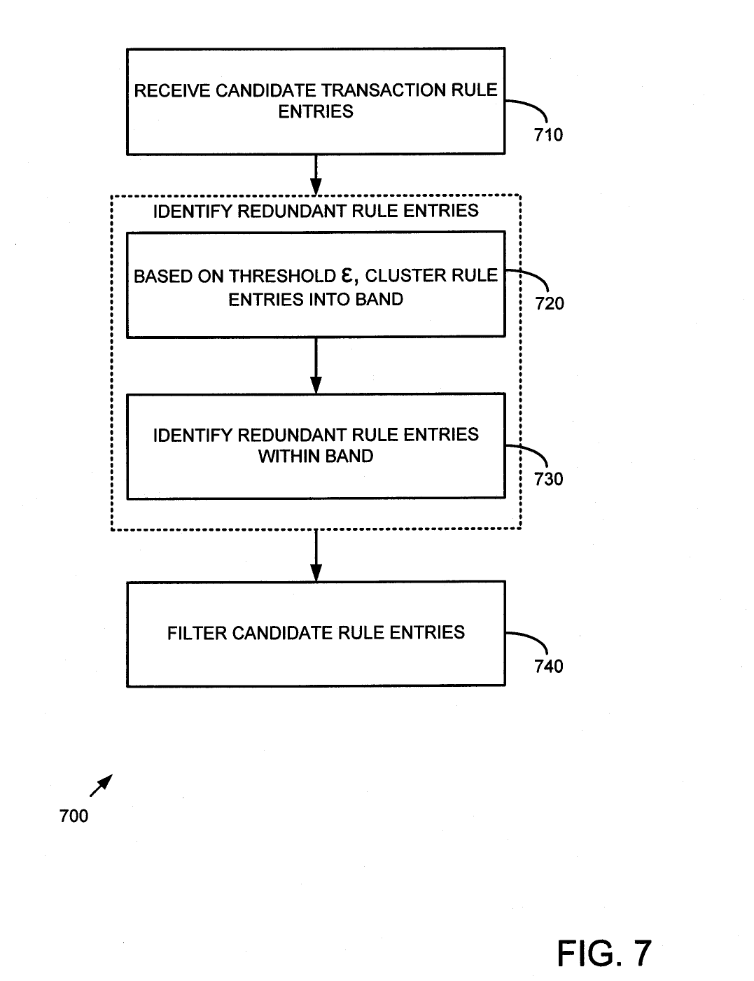

FIG. 7 is a flowchart of an exemplary method 700 implementing filtering of redundant consumer transaction rules via support bands.

At 710, candidate transaction rule entries can be received as described herein.

Identifying redundant rule entries can comprise 720 and 730. At 720, based on a support threshold c, rules are clustered into bands based on their support ratings. Various clustering techniques (e.g., nearest neighbor and the like) can be used. Clustering can cluster one rule entry with an other rule entry having a different (e.g., non-identical) support rating.

At 730, redundant rules are then identified within the support band. For example, rules within the support band can be considered to be sufficiently close for redundancy purposes. As described herein, rules can be assigned to clusters, and those rules in the same cluster can be considered sufficiently close for redundancy purposes.

As described herein, the rule entries within a band can be checked for containment relationships. Those rule entries within a band having such containment relationships (e.g., a rule entry that contains another rule) can be identified as redundant.

As described herein, rules can be grouped according to containment relationships, and support ratings can be checked (e.g., based on a support threshold c) within the groups to see if they are sufficiently close. In such a case, determining that support ratings are sufficiently close is performed after identifying a containment relationship. Such an arrangement typically results in better redundancy removal.

At 740, the candidate rule entries are filtered as described herein (e.g., by removing redundant rule entries).

### Example 18

### Exemplary System Filtering Via Bit Vectors

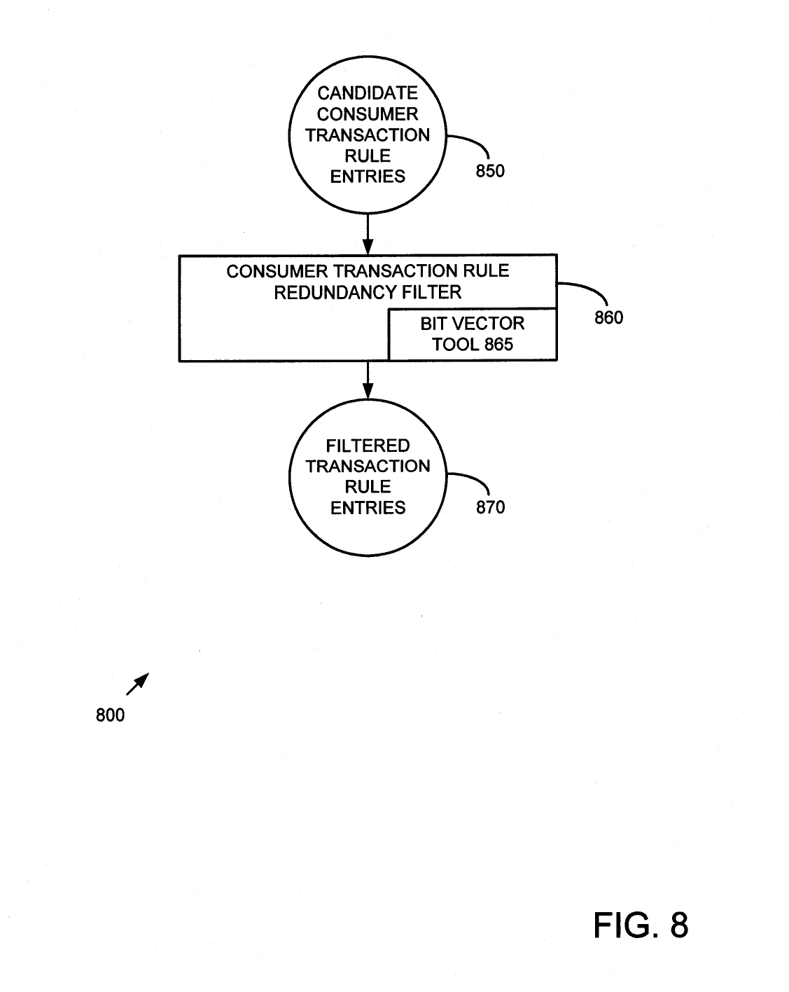

FIG. 8 is a block diagram of an exemplary system 800 implementing filtering of redundant consumer transaction rules with a bit vector tool 865.

In the example, the candidate consumer transaction rule entries 850 and the filtered transaction rule entries 870 can take the form of rule entries as described elsewhere herein.

The redundancy filter 860 includes and can interact with a bit vector tool 865, which can use any of the bit vector techniques herein to determine whether two rule entries have a containment relationship. For example, for a pair of rule entries, respective bit vectors can be assigned and evaluated to generate a result indicating whether a containment relationship exists. As described herein, the tool 865 can treat missing values as having a value of any.

Although not shown in FIG. 8, any of the systems herein can include a user interface displaying a list of filtered rule entries (e.g., ranked by support rating).

### Example 19

### Exemplary Method Filtering Via Bit Vectors

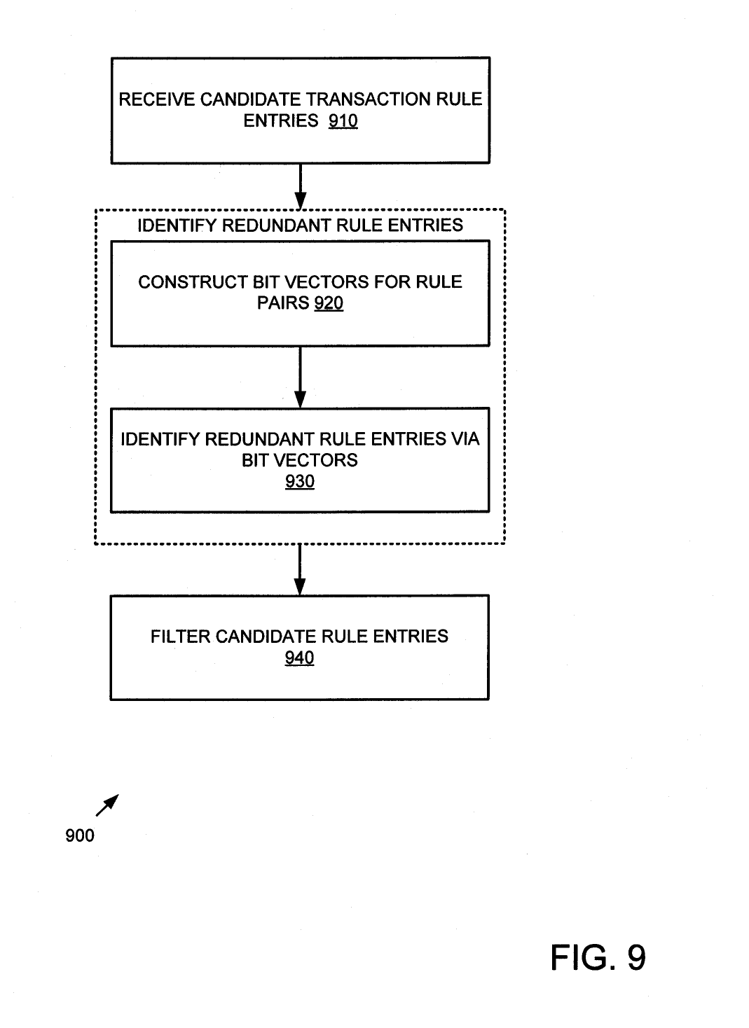

FIG. 9 is a flowchart of an exemplary method 900 implementing filtering of redundant consumer transaction rules via bit vectors.

At 910, candidate transaction rule entries can be received as described herein.

Identifying redundant rule entries via bit vectors can comprise 920 and 930. At 920, bit vectors are generated for rule pairs. A bit vector pair can be generated for a respective pair of the candidate consumer transaction rule entries based on comparison of individual consumer characteristic values in the pair of the candidate consumer transaction rule entries.

At 930, the bit vectors are evaluated to determine whether the rule entries exhibit a containment relationship. If a rule entry exhibits such a relationship (e.g., contains another rule entry), it can be further analyzed to determine whether support ratings between the two rules are sufficiently close. If so, the rule entry can be identified as redundant.

As described herein, it is possible to cluster rule entries according to their support ratings before identifying containment relationships (e.g., with bit vectors). In such a case, determining that support ratings are sufficiently close is performed before identifying a containment relationship.

At 940, the candidate rule entries are filtered as described herein (e.g., by removing redundant rule entries).

### Example 20

### Exemplary Bit Vector Assignment

In any of the examples herein, bit vectors can be assigned, one bit per consumer characteristic when comparing two rule entries as follows to a rule in question (Rᵢ) and another rule (Rⱼ):

| Rᵢ | Rⱼ | Bit for Rᵢ |
|---|---|---|
| Any | Any | 0 |
| Value | Any | 1 |
| Any | Value | 0 |
| Value | Value | 1 |
| Value | Different Value | Independent |

If the bit vectors Rᵢ and Rⱼ have different non-any values for a consumer characteristic, there is no need to check for containment because the rule entries are independent. Bit vector processing can be skipped for such independent rules.

If Rᵢ and Rⱼ have identical values for all consumer characteristics, they are identical, and can be treated as such (e.g., one can be removed as if it is contained within the other).

### Example 21

### Exemplary Bit Vector Evaluation

In any of the examples herein, bit vectors for two rule entries (e.g., a pair of bit vectors) can be evaluated by performing a logical and on the pair of vectors, producing a resulting bit vector. The resulting bit vector can then be compared to the bit vectors of each rule (e.g., to the bit vectors in the pair). If the resulting bit vector matches the bit vector of either of the rules, the rule with the matching bit vector has a containment relationship (e.g., contains the other rule) and can be removed as redundant if support ratings are sufficiently close between the rules.

### Example 22

### Exemplary Developers

In any of the examples herein, a developer can be any party or entity developing applications and/or uploading applications to an application store for access by application store consumers. As described herein, such developers can benefit greatly from the described technologies.

### Example 23

### Exemplary Combinations

In any of the examples herein, any of the support closeness techniques can be used in conjunction with any of the bit vector techniques described herein.

### Example 24

### Exemplary Consumer Transaction Rules

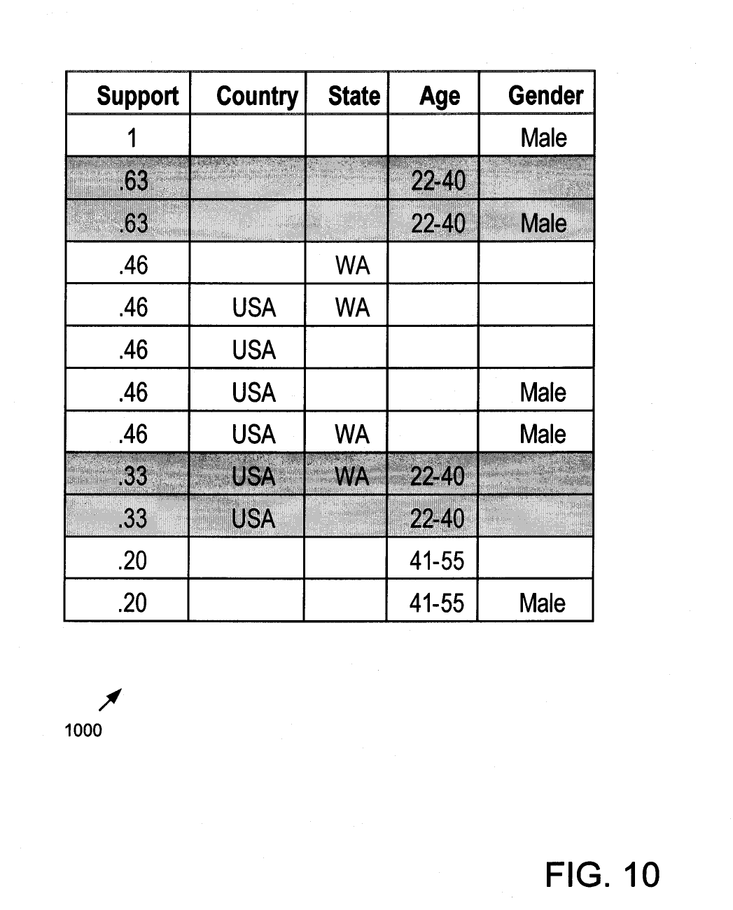

FIG. 10 is a table 1000 showing exemplary consumer transaction rules. In the example, it is apparent that the rules indicate that 100% (support rating of 1) of the transactions involved Male consumers.

Another rule indicates that 63% of the transactions involved consumers in the 22-40 age bucket. Such a rule is redundant with another rule indicating that 63% of the transactions involved consumers in the 22-40 age bucket and are male. There are other redundant rules shown.

### Example 25

### Exemplary Anyfication of Consumer Transaction Rules

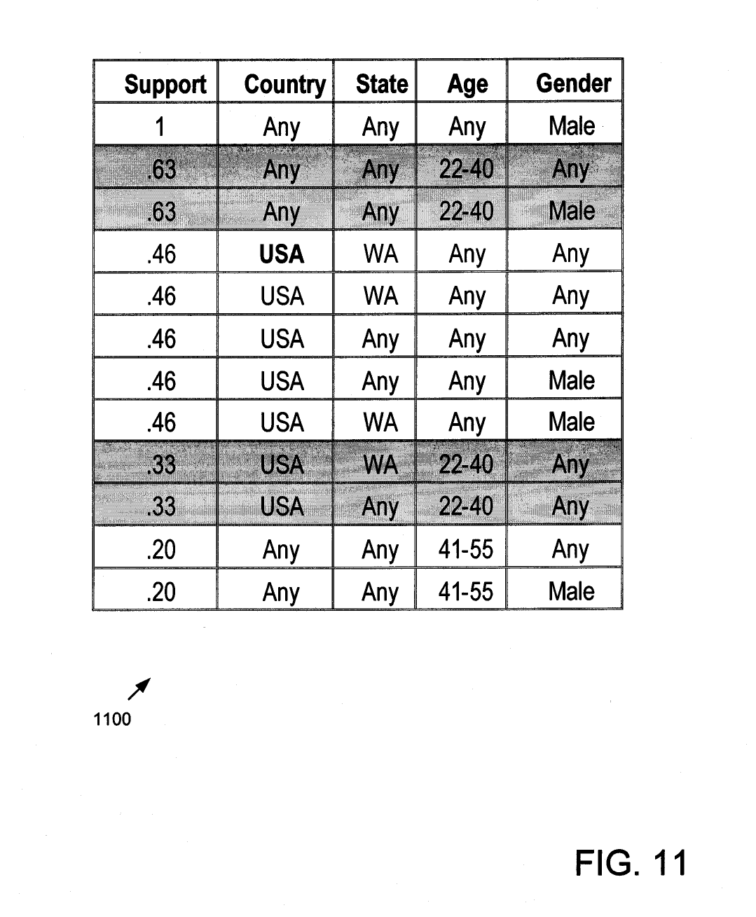

FIG. 11 is a table 1100 showing exemplary consumer transaction rules with anyfication applied. In any of the examples herein, analysis of the rule entries can proceed with advantage when missing values are considered to have the value “any.” Such a technique, called “anyfication” can be applied in any of the examples described herein. In practice, the value “any” can be represented in a variety of ways, including special codes or pointers.

Anyfication can indicate a value of any for one or more consumer characteristic values not present in a first candidate consumer transaction rule entry but present in an other candidate consumer transaction rule entry.

One of the values is instead corrected to be “USA” because domain-specific knowledge assures that the state “WA” necessarily means that the value for country is “USA.”

### Example 26

### Exemplary Bit Vector Evaluation

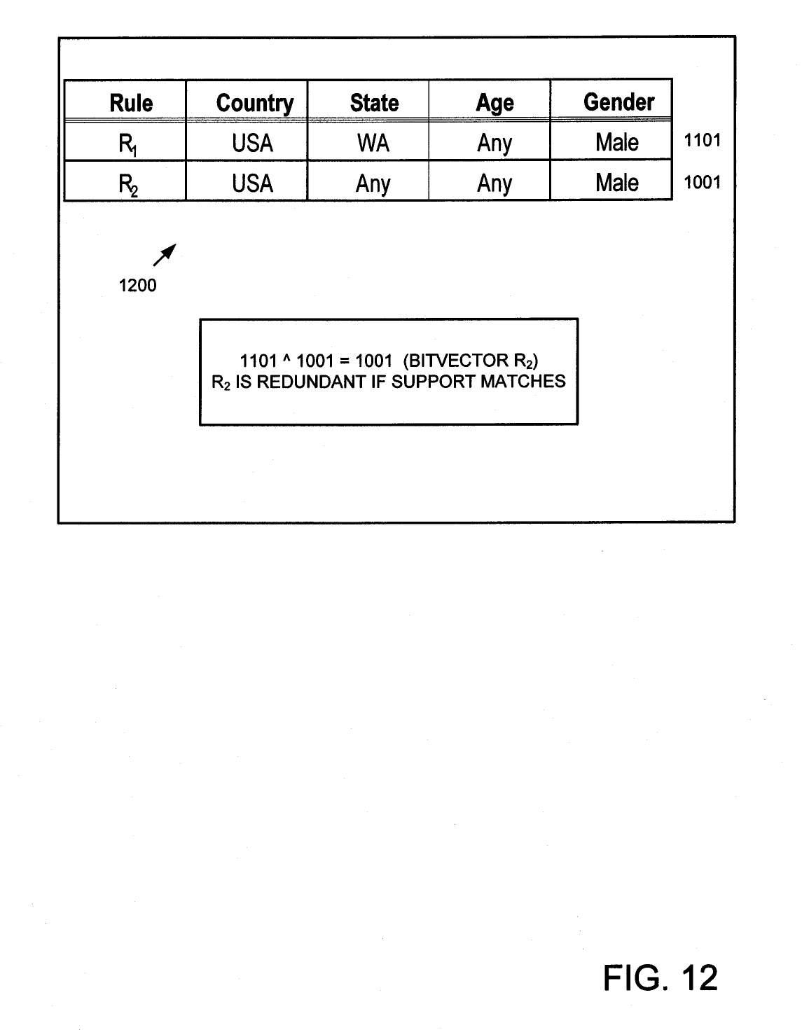

FIG. 12 is a table 1200 showing redundancy filtering via bit vector. In the example, R₁ and R₂ are evaluated to determine whether a containment relationship exists. The bit vectors (1101 for R₁ and 1001 for R₂) are constructed according to the bit vector assignment technique described herein.

When a logical and is performed (e.g., shown as ̂ in the drawing), the resulting bit vector (1001) matches R₂, so R₂ is contained by R₁. Accordingly, R₂ is redundant if the support ratings for the two rules are sufficiently close.

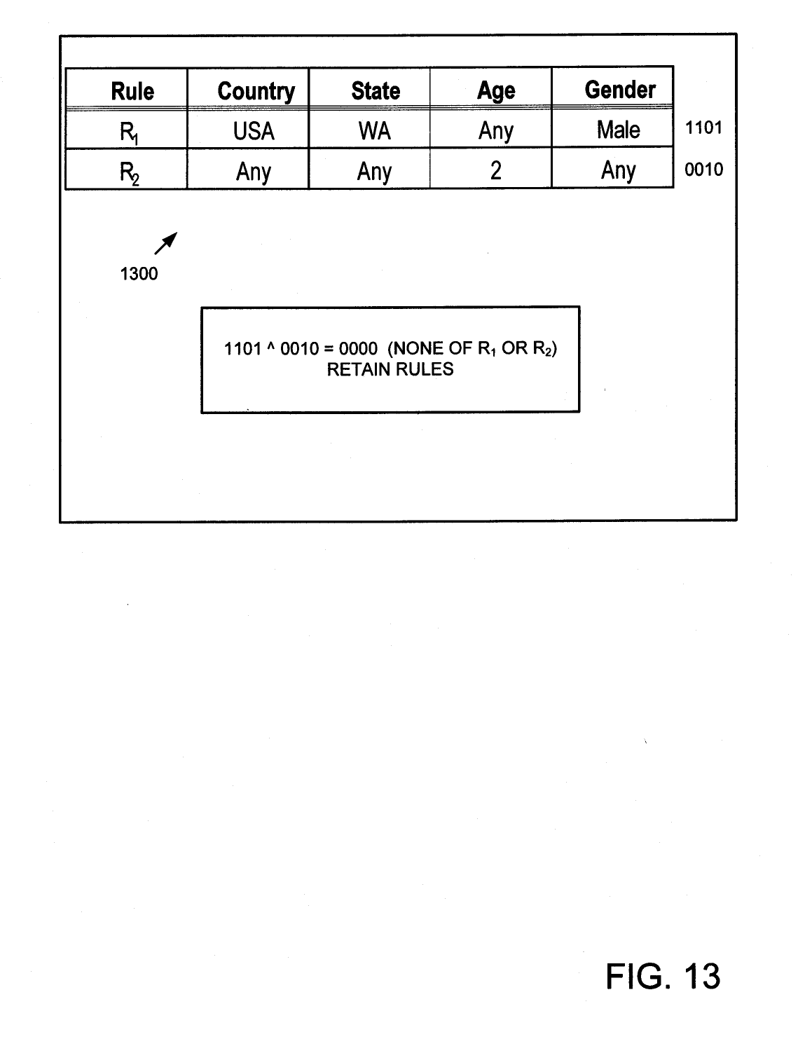

FIG. 13 is another table 1300 showing redundancy filtering via bit vector. In the example, the bit vectors (1101 for R₁ and 0010 for R₂) are constructed according to the bit vector assignment technique described herein.

When a logical and is performed, the resulting bit vector (0000) matches neither R₁ nor R₂, so neither rule has a containment relationship. Accordingly, the rules are retained and considered independent.

### Example 27

### Exemplary Performance Metrics

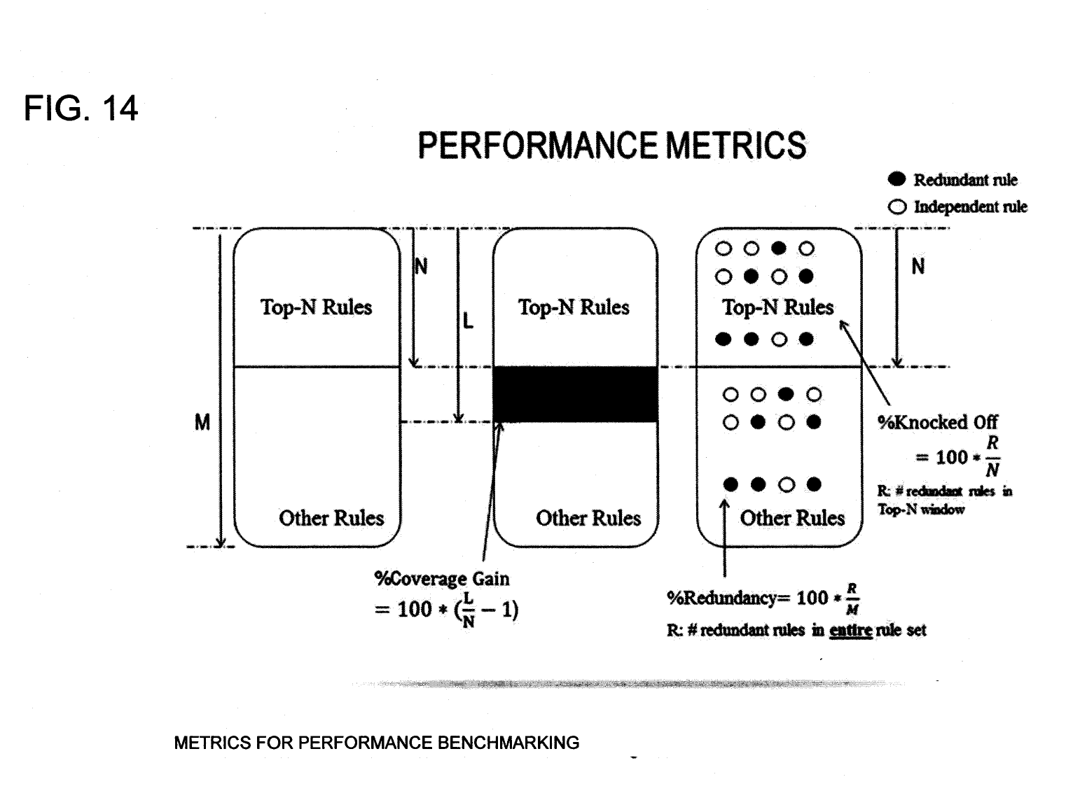

FIG. 14 is a block diagram showing performance metrics for redundancy filtering.

In the examples, there are M rules in a top N window. Such an arrangement is a useful way to analyze scenarios in which the top N rules are conveyed to a user for consideration. Although N can take any of a variety of values, one implementation uses N=5.

A coverage gain percentage can be calculated as 100*((L/N)−1), where L determines the number of rules that had to be scanned (e.g., typically beyond N) from the Top (e.g., ordered based on support) to avoid redundant rules before the number (N) of Top-N rules could be shortlisted. In other words, the coverage gain measures the additional amount of coverage depth into the rules gained by removing redundant rules that goes beyond that originally possible when limited to a window of N rules without having removed redundant rules.

Such a coverage gain metric can be calculated by, for a top N window of filtered rule entries ranked by support rating, determining a ranking (e.g., in descending order of support values), L, of a Nth rule entry in the original rule set (e.g., the candidate consumer transaction rule entries) and calculating a coverage gain metric comprising calculating (L/N)−1. A percentage coverage gain metric can be calculated as 100*((L/N)−1).

A redundancy elimination percentage metric can proceed without regard to N or a Top-N scenario. The entire set of discovered (e.g., candidate, whether redundant or not) rules can be scanned (e.g., qualified by a minimum support value). It can then be discovered what percentage of rules are redundant in the entire gamut of discovered rules.

Such a redundancy elimination metric can be calculated by dividing the candidate consumer transaction rule entries identified as redundant by the total number of candidate consumer transaction rule entries. A percentage redundancy elimination metric can be calculated by multiplying by 100.

Out of the top-N rules in the candidate rules, one can find how many (e.g., R) rules have been knocked off as redundant by the techniques described herein. The knock-off percentage can be calculated as 100*(R/N).

Such a knocked off metric can be calculated by, for a top N window of candidate consumer transaction rule entries, determining a number of candidate transaction rule entries filtered, R, as redundant. Calculating the knocked off metric comprises calculating R divided by N. A percentage knocked off metric can be determined by multiplying by 100.

The metrics can be particularly helpful to demonstrate the advantage of the techniques described herein, such as efficiency of the rule redundancy removal techniques when displaying the rules within a limited window as described herein.

### Example 28

### Exemplary Nearest Neighbor Technique

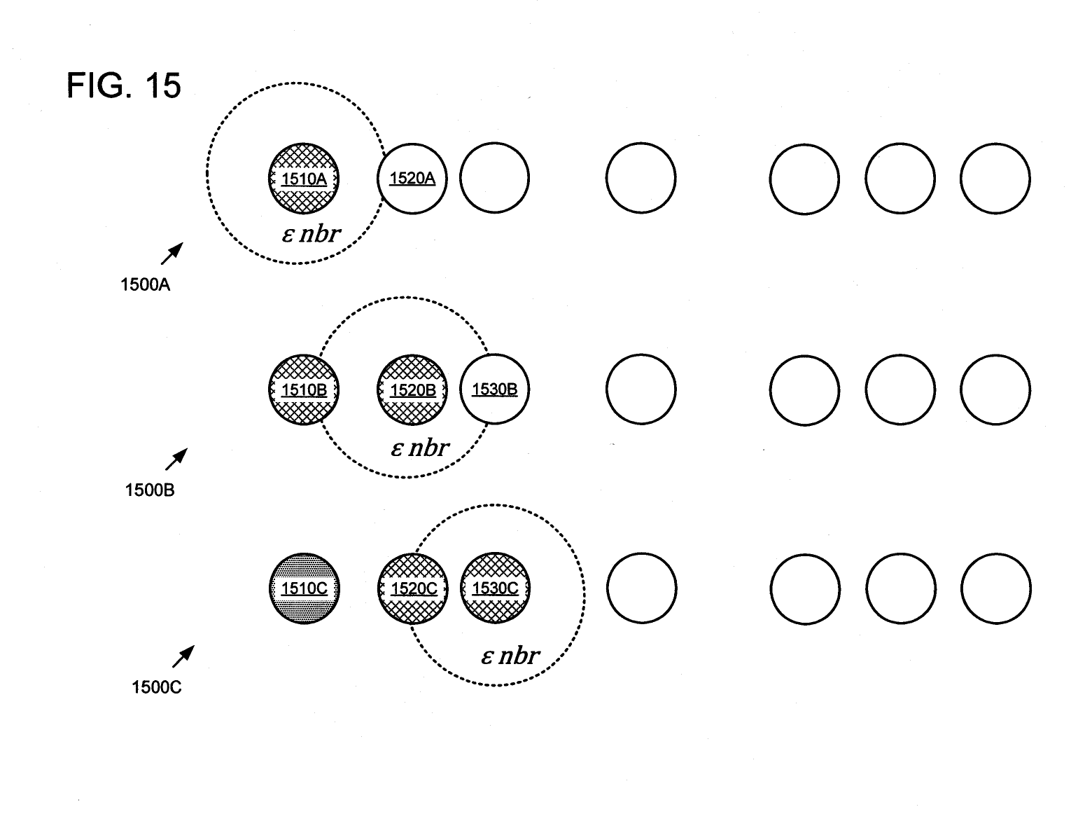

FIG. 15 is a block diagram showing application of a nearest neighbor technique to achieve redundancy filtering. Although any number of clustering techniques can be applied herein to achieve clustering of rule entries by support rating, the nearest neighbor technique is shown as one example.

At 1500A, analysis starts at a first rule 1510A, and it is determined that another rule 1520A has a support rating within a threshold ε of the first rule 1510A. Analysis then proceeds to the rule 1520A.

Analysis continues at 1500B, where it is determined that rule 1530B has a support rating within a threshold ε of the rule under analysis 1520B. Accordingly, analysis then proceeds to the rule 1530B.

At 1500C, it is discovered that rule 1510C is not within the threshold of 1530C. Accordingly, 1510C is marked as not being within the same cluster as 1520C and 1530C (e.g., 1510C is not the nearest neighbor of 1530C).

Analysis can continue similarly with the other rules in the group.

### Example 29

### Exemplary Overall Architecture

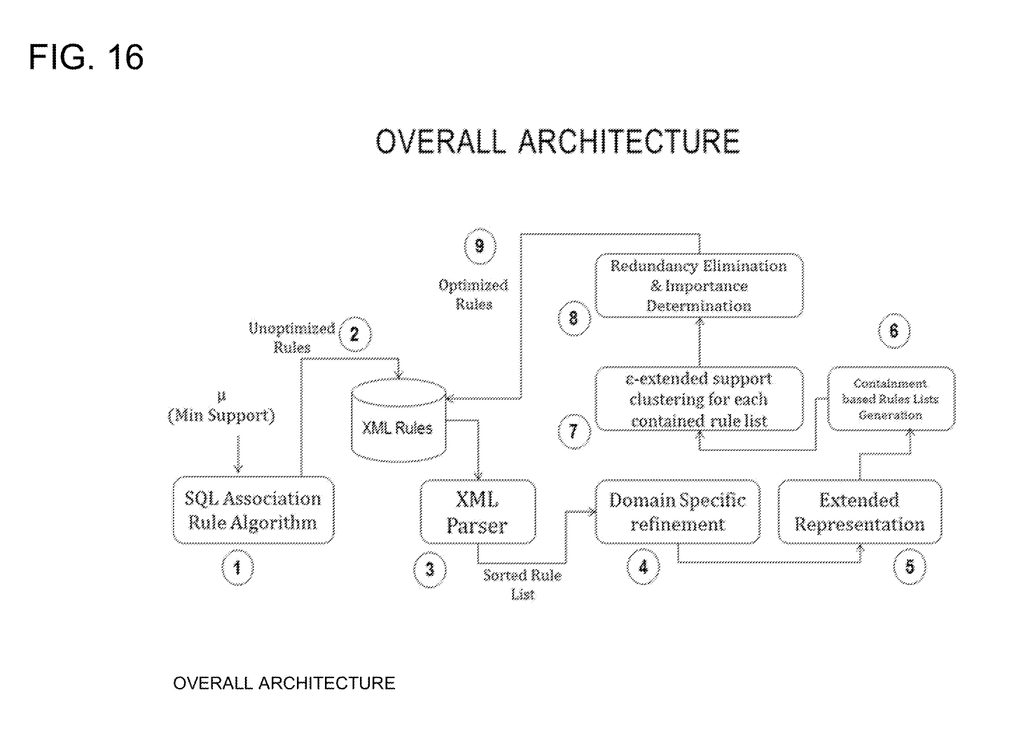

FIG. 16 is a block diagram of an exemplary architecture for achieving redundancy filtering. In the example, rules are represented in XML, but other representations are possible as described herein.

A minimum support threshold μ is used to generate rules with an SQL Association Rule Algorithm. Such rules can be called “unoptimized” (e.g., candidate rules) because they have not yet been filtered for redundancy.

The rules are stored in XML rules and parsed by an XML parser, which generates a sorted rule list.

Domain-specific refinement as described herein can be applied, and the rules can be placed into extended representation (e.g., anyfication and the like).

Containment-based rules lists can be generated. For example, the rules can be placed into lists of other rules with which they have a containment relationship. As described herein, such lists can be ordered based on containment relationship. Such ordering can be from most general to least general or vice versa (e.g., from container to containee or vice versa).

For the rule lists, ε-extended support clustering can be performed for the contained rule lists.

Redundancy can then be eliminated according to the containment relationships and support ratings. Importance determination (e.g., higher ranked, more characteristics, and the like) can then be performed, resulting in optimized rules (e.g., rules filtered for redundancy, ranked by support, and placed in a top-N window).

### Example 30

### Exemplary Further Information

An application store can offer a platform to consumers to discover, try and buy new applications of choice at ease. A Developer Miner (DM) component can provide (data driven) business direction to a developer whose application (“app”) is distributed through the application store. One of the functionalities of the Developer Miner is to mine business patterns (aka business rules) from recorded (download) transactions for an app (‘L3’ Adoption Page), compare the same against the aggregated (download) trend for an app's (sub-) category (New Business Opportunities i.e. NBO Page). This helps a developer realign her business strategy based on real world consumption of her app.

One can use SQL Server Analysis Services Association Rules (AR) techniques to extract business rules from the consumer transactions. Unfortunately, AR generates highly redundant rules. Assuming a rule is represented as sequence of Attribute Value Assertion (AVA-s), for example, {Country=“USA”, State=“Washington”, Age=[0-13], Gender=“male”} will represent one of the business rules discovered by DM from the (download) transactions of consumers. In the above example, the presence of redundant rules having (approximately) same frequency such as {Country=“USA”, State=“Washington”, Age=[0-13]}, {Country=“USA”, State=“Washington”}, {Country=“USA”} is highly likely. This floods the limited real estate (display) with redundant rules resulting in poor user experience.

Hence, it is desirable to (1) identify non redundant business rules automatically for elimination, (2) rank order the rules to show the most important ones at the top to maximize user experience, and (3) come up with metrics to evaluate performance of such algorithms.

As described herein, techniques to deal with the problem can be implemented in Application Store Developer Analytics. The techniques correctly identify redundant rules through a containment relationship facilitated by a unique rule representation scheme. New metrics have been defined (% Redundancy, % Coverage Gain, % Knock-Off) which help in benchmarking algorithms in this space. Using real world application store data, one can get, on an average, 40%+ as the % Knock-off, 30% Redundancy and 58%+ Coverage Gain. This means for a Top-5 (with respect to ‘support’ of a rule) scheme, 2 rules on an average will be replaced by more meaningful rules. Additionally, the algorithm scans beyond the Top-5 (i.e. 58% Coverage Gain implies scanning of Top-8 rules) rules to look for non-redundant ones as against selecting just from the Top-5.

### Example 31

### Exemplary Further Information

Techniques described herein reduce the redundancy of the generated business patterns (rule) involving a given set of attributes. A rule can be represented as a sequence of AVAs (Attribute Value Assertion).

One can take advantage of the fact that an attribute, if absent within a rule, is equivalent to the attribute possessing “any” value. In other words, the rule is agnostic of the value of that attribute. This reduces the problem of identifying redundancy into the problem of detecting subsets (more specific rule) of a given set (more generic rule) of AVA sequence. One can associate a bit vector with a generated rule that can be manipulated to detect this containment relationship between rules. A pruning decision is taken based on the joint outcome of the minimum support of a rule, containment relationship with other rules based on bit vector manipulation and domain specific redundancy identification.

Particular techniques can be fast and can replace on an average by 40% or higher from Top-5 rules on real world data. Additionally, more than 80% of the models whose rules were to be displayed in Top-5 window resulted in redundancy elimination proving its effectiveness in improved user experience.

### Example 32

### Exemplary Representation

Consumer transaction rules generated based on consumer transactions can be optimized (e.g., filtered for redundancy) for display in an Application Store monitoring application for a developer. The same approach towards optimizing rules can be applied to rules generated using a Decision Tree (DT) technique.

Rules can be stored in XML format within the system even though this is not a requirement.

Let the overall set of attributes in the mining system be represented by Ω. A rule discovered by an association rules technique is a sequence of attribute-value assertions, i.e.,

Rᵢ:{(Aₖ=v_{k,j}),k∈[1,Nᵢ],j∈[1,Vₖ],Aₖ∈Ω} where,
v_{k,j} is the j^{th} value of the k^{th} attribute, Aₖ,
Vₖ is the number of possible values of Aₖ,
V_{k,j}∈val(Aₖ) i.e. the value set of Aₖ, and
Nᵢ is the number of attributes involved in the i^{th} rule i.e. R.

The set of qualified rules, γ, are those who have their support greater than a minimum threshold value (μ)

For an application store, for example,
Ω={Country (=A₁), State(=A₂), Age Bucket(=A₃), Gender(=A₄)}
‘val(A₁)’ can assume values such as {USA, England, India, . . . }, likewise other variables have their own set of values.
A typical rule, R, can be of the form: {Country=‘USA’, State=‘Washington’, AgeBucket=‘15-30’, Gender=‘male’}

### Example 33

### Exemplary Anyfication Rule Representation

An extended representation of rules generated from consumer transactions can be used. It is not necessary that a rule, ‘R’, has attribute-value assertions involving all the attributes of Ω. There may be a few attributes (MAᵢ) missing in R.

Such missing attribute-value assertions (AVAs) can be complemented as {(MAᵢ=‘any’)} indicating that the rule is agnostic of the values {MAᵢ} may assume. Thus the extended representation of a rule, R: {Country=‘USA’, Gender=‘male’} is tantamount to {Country=‘USA’, State=‘any’, Age Bucket=‘any’, Gender=‘male’}. Note how the missing attributes {State, Age Bucket} have been filled with ‘any’ values in extended representation mode.

In extended representation, rules in the system can involve missing attributes (e.g., attributes for other rules, such as the attributes appear in any of the other rules) of Ω.

### Example 34

### Exemplary Redundant and Independent Rules

The technologies described herein can discover if two rules are independent or one is redundant given the other. The following definitions can be used to help identify redundant & independent rules.

Two rules, Rᵢ and Nⱼ, having extended representation, possess set-subset relationship making one of them redundant if:

Their support are equal (or close as described herein), and

One of the rules, say (Rᵢ), is more general than the other (Rⱼ) in their extended representation if
Either [AVAₖ matches exactly for Rᵢ & Rⱼ]
Or [Aₖ must be ‘any’ for Rᵢ and Aₖ must NOT be ‘any’ for Rⱼ]

Two rules, Rᵢ and Rⱼ, are independent if they are not redundant.

### Example 35

### Exemplary Determination of Redundant and Independent Rules

Based on the above, a technique to determine redundant & independent rules can be as follows.

(Relative) bit vectors of rules (Ri & Rj) can be defined having same (e.g., or close enough) support in the context of each other as follows:

[For each k=1, |Ω|]

1. For an attribute-value assertion involving the k^{th} attribute, Aₖ, in Rᵢ & Rⱼ having same support,
A. If val(Rᵢ:Aₖ) i.e. the value of attribute Aₖ in Rᵢ equals val(Rⱼ:Aₖ) then put a ‘1’ for each of Rᵢ & Rⱼ at the k^{th} bit position in the resultant bit vectors for each of Rᵢ & Rⱼ. This holds exclusively for every non-‘any’ values of Aₖ in both the rules.
B. If in any of Rᵢ & Rⱼ, Aₖ has a value equal to ‘any’ and the other assumes a non-‘any’, put a ‘0’ in the bit vector representation of the corresponding rule while putting a ‘1’ in the other rule.
C. If the values of Aₖ in both Rᵢ & Rⱼ equal ‘any’, put ‘0’ in the k^{th} position of the bit vector representation of both the rules.

2. For example, if Rᵢ={Country=‘USA’, Age Bucket=‘15-30’} & Rⱼ={Age Bucket=‘15-30’}, then follow the steps below to arrive at their relative bit vectors:
A. [By Extended Representation]
   Rᵢ={Country=‘USA’, State=‘any’, Age Bucket=‘15-30’, Gender=‘any’} &
   Rⱼ={Country=‘any’, State=‘any’, Age Bucket=‘15-30’, Gender=‘any’}
B. [Bit Vector Representation]
   Bit Vector of Rᵢ relative to Rⱼ=Bit VectorRⱼ(Rᵢ)=1010
   Bit Vector of Rⱼ relative to Rᵢ=Bit VectorRᵢ(Rⱼ)=0010

3. [Redundancy & Independence Test] To test for redundancy involving Rᵢ & Rⱼ do the following:
A. Compute: F=Bit VectorRⱼ(Rᵢ)ΛBit VectorRᵢ(Rⱼ) [bitwise AND operation]
   [Case F==Rⱼ] Rⱼ is superset (i.e. more general) of Rᵢ. If so, declare Rⱼ to be redundant and include Rᵢ only in display.
   [Case F==Rᵢ] Rᵢ is redundant and remove the same from display.
   [Case F≠any of Rᵢ or Rⱼ] Rᵢ and Rⱼ are independent and retain both in the display.

### Example 36

### Exemplary Proof that Above Technique for Independence and Redundancy Works

Take two rules {R_{A}, R_{B}} each of which is a sequence of AVAs. Focusing on the i^{th} AVA & j^{th} AVA. Such AVAs will be of the form, {R_{A}: Aᵢ=^{A}vᵢ, R_{B}: Aᵢ=^{B}vᵢ} & {R_{A}: Aⱼ=^{A}vⱼ, R_{B}: Aⱼ=^{B}vⱼ}. This is due to the strategy of anyfication or extended rule representation to ensure that every attribute is present in each rule. Without any loss of generality (as there were no restrictions put in the choice of ‘i’ and ‘j’), one can assume that the rest of the attributes other than {Aᵢ, Aⱼ} are the same. The partially developed bit vector is the same, say ‘Y’. This is because one can always build the rules ground up by adding one AVA at a time. Consider the following cases:

Case-I: {^{A}vᵢ=^{B}vᵢ} The generated bit vector for each of R_{A} & R_{B} will be “Y1” and hence remains the same. If this continues to happen across all the attributes, the generated bit vector is exactly the same for both the rules. Their AND operation would have equaled the bit vector of any of the rules and algorithm would have eliminated one of the rules (duplicate). This also takes care of eliminating “any=any” cases.

Case-II: {^{A}vᵢ≠^{B}vᵢ} The generated bit vector for each of R_{A} & R_{B} will now depend on value of Aᵢ.

In case one of them (say ^{A}vᵢ) is ‘any’ and the other (^{B}vᵢ) is not, bit vector of R_{A} would be “Y0” while that for R_{B} will be “Y1”. AND operation of the two bit vectors now becomes “Y0” equaling that of R_{A} which is more general than R_{B}. The algorithm works correctly in such case.

In case where both values are different from ‘any’, and are unequal, the technique would have correctly identified them as independent (See the exemplary determination of redundant and independent rules, above).

Case III: {^{A}vᵢ≠^{B}vᵢ, ^{A}vⱼ≠^{B}vⱼ, i<j} This is a case where it can be safely assumed that all the other attributes (Aₖ: i≦k≦j) in between agreed in their values else it would have landed in either Case-I or Case-II. A case where {^{A}vᵢ‘any’≠^{B}vᵢ, ^{B}vⱼ=‘any’≠^{A}vⱼ} apparently presenting a conflicting situation where the correct decision is to declare these rules as independent.

The bit vector for R_{A} would have evolved as “Y0A1” while that of R_{B} would have become “Y1A0”. Again doing an AND operation on this subsequence resulted in bit vector “Y0A0” which is different from both R_{A} or R_{B}. The algorithm will correctly identify R_{A} & R_{B} as independent.

Q.E.D.

### Example 37

### Exemplary ε-Extension of the Definition of Support for Redundant & Independent Rules

The restriction of two rules having same support to be considered for independence or redundancy can be relaxed. In any of the examples herein, the concept can be extended to include ε-extension of the support. Two rules (e.g., Rᵢ and Rⱼ) qualify to be considered for independence or redundancy tests if their support vary by at most ε, i.e. |Sup(Rᵢ)-Sup(Rⱼ)|<ε. One can refer to this as Rᵢ & Rⱼ having same ε-extended support.

Technique Modification to take care of ε-extension: Modify the Technique (e.g., refer to Example 35) to include ‘ε-extension’ as follows:

Partition γ into ε-extended support bands (e.g., refer to Examples 38 and/or 41).

Repeat steps of the technique (e.g., refer to Example 35). NOTE: Wherever rules are being compared against their support, replace ‘support’ with ‘cluster ID’ for each rule. After partitioning as above, the only metric for each rule is its ‘cluster ID’ instead of support. For example—only rules which belong to the same cluster ID (erstwhile ‘support’ was used) will be picked up for determining their redundancy.

### Example 38

### Exemplary Partitioning Rule Set into ε-Extended Support Bands

The rule set, γ, can be partitioned into ε-extended support bands using any of a variety of clustering techniques, such as an ε-neighborhood clustering technique. Nearest neighbor clustering can be used.

### Example 39

### Exemplary Metrics for Performance

The following metrics quantify performance of the techniques. In all the metrics below, one can assume, γ, to be the set of qualified AR rules where each rule has support ≧μ and they are arranged in decreasing order of their support. One can also assume that finally a developer gets to see only Top-λrules in the system.

Redundancy Elimination (% RE): It captures (%) of total (|γ|) rules which were marked redundant by the algorithm.

(%) Coverage Gain (% CG): If the last rule to make into Top-λ window post redundancy elimination is ranked ‘δ’ in original rule set, ‘γ’, then,

$$\% C G = ( \frac{6}{λ} - 1 )$$

(%) Knock Off (% KO): This metric indicates (%) of the top (λ) rules out of the maximum of ‘N’ rules to be displayed which were knocked off as redundant by the algorithm.

The above metrics are extremely useful for determining the success of such algorithms. FIG. 14 illustrates further details.

### Example 40

### Exemplary Technique for Rule Ordering

A framework can begin automated ordering of the rules to maximize exposure of non-redundant rules into a Top-λ window.

Input:
Set of AR generated Rules: γ. This set of rules is sorted in decreasing order of support of its constituent rules. It is ensured that all rules have support >μ. ‘μ’ (e.g., 0.01) is known as the minimum support of a rule.
‘λ’ (<<|γ|) as in Top-λ window containing top λ rules visible to a developer

Output:
Revised set (γₙᵣ) of non-redundant rules. Pick top λ from this list to fill Top-λ window.

Assumption
Rules have associated data structures as detailed implementation requires. In the steps below, a rule has ‘status’ as one of its fields having values within {In, Out}. This indicates if a rule is independent (‘In’) or redundant (‘Out’).

Acts:

```
    1. Begin
    2. define γₙᵣ and initialize γₙᵣ← Φ (null set)
    3. for each rule rεγ
        a. convert ‘r’ to its extended representation (e.g., refer to Example 33) by
inserting ‘any’ value for every missing attribute, AεΩ and A∉ r
        b. r.status ← ‘In’
    4. for each ( rᵢεγ, i ε [1, |γ| )
        a. if (rᵢ.status == ‘Out’) skip rest and start next iteration [i-loop];
        b. for each ( rⱼεγ, j=i+1 & j<|γ| )
            i. if (rⱼ.status == “Out”) skip the rest and start next iteration [j-loop];
            ii. check if (rᵢ, rⱼ) is either:
                independent (e.g., Example 35)
                    If so, γₙᵣ ← γₙᵣ U {rᵢ, rⱼ}.
                    rᵢ.status ← ‘In’;
                    rⱼ.status ← ‘In’;
                redundant (e.g., Example 35).
                    If (rᵢ is redundant) { rᵢ .status← ‘Out’; rⱼ .status← ‘In’;
γₙᵣ ← γₙᵣU{rⱼ}}
                    otherwise { rⱼ .status←‘Out’; rᵢ .status←‘In’; γₙᵣ ←
γₙᵣU{rᵢ}}
        c. end for (j-loop)
    5. end for (i-loop)
    6. ‘γₙᵣ’ contains the independent rules ordered in descending support of the rules.
Alternatively, γ contains rules whose ‘status’ filled has been marked as ‘In’ or ‘Out’ and is as
useful as ‘γₙᵣ’.
    7. End
```

### Example 41

### Exemplary Clustering Technique to Create ε-Extended Support Bands

A clustering technique (e.g., nearest neighbor) can be used for this problem.

Input:
Set of AR generated Rules: γ. This set of rules is sorted in decreasing order of support of its constituent rules.
‘ε’ i.e. support band within which rules will be considered to have same ‘extended support’ value (e.g., be sufficiently close).

Output:
The set, γ, of rules where every rule is assigned a unique cluster ID.
Number of unique clusters, C, discovered

Assumption
A rule has associated data structure according to its detailed implementation—specifically, a rule has the following fields:
   ‘support’ that indicates frequency of occurrence of the itemset (AR terminology).
   ‘status’ that indicates if the rule is redundant (‘Out’) or important (‘In’)
   ‘clusterid’ that indicates to which cluster the rule belongs

Acts:

```
    1. {
    2. Define two integer arrays i.e. sortedIndex[|γ|], clusterIDs[|γ|]
    3. Define a double array, value[|γ|], that stores support for each rule, r ε γ
    4. Initialize sortedIndex[ ] array with indices of value[ ] array in descending order of
values
    5. Initialize clusterIDs[ ] entries to ‘−1’
    6. lastgrp ← 0; clusterIDs[sortedIndex[0]] ← lastgrp; indmaxlastgrp← 0;
alreadyentered=false;
    7. for (cnt=1; cnt<|γ|; cnt++) do
    8. {
    9. val1 = value[sortedIndex[indmaxlastgrp]] − value[sortedIndex[cnt]];
    10. if (val1 ≦ ε)
        a. clusterIDs [sortedindex[cnt]] = clusterIDs [sortedindex[cnt − 1]]; /* Belongs
to same cluster */
    11. else
        a. {
            i. clusterIDs [sortedindex[cnt]] = clusterIDs [sortedindex[cnt − 1]] + 1;
            ii. alreadyentered = false;
            iii. /* Realign old members into new cluster if applicable */
            iv. for (j= indmaxlastgrp+1; j<cnt; j++)
            v. {
            vi. val2 = value[sortedIndex[j]] − value[sortedIndex[cnt]];
            vii. if (val2 < ε)
            viii. {
                if (!alreadyentered) { indmaxlastgrp =j; alreadyentered= true;}
                clusterIDs [sortedindex[j]] = clusterIDs [sortedindex[cnt]];
            ix. }
            x. } /* End of inner for loop */
            xi. If (!alreadyentered) indmaxlastgrp=cnt;
        b. }
    12. } /* End of for loop */
    13. /* Recalculate how many unique clusters were created */
    14. C = clusterIDs [sortedindex[|γ|]] +1;
    15. } /* End of clustering */
```

### Example 42

### Exemplary Modification of Technique to Include ε-Extended Support Bands

To take into account ε-extended support (e.g., in Example 41), one can follow the acts below:

Cluster rules [γ] into ε-bands and assign Cluster ID to each rule (e.g., in Example 41). In principle, any clustering algorithm can be used here.

Modify the technique (e.g., Example 35) to compare only Cluster IDs instead of raw support for involved rules (e.g., replace the clause ‘having same support’ with ‘having same Cluster IDs’).

With the modification above, the final technique acts look as follows (The departure from the technique without ε-extension is highlighted below):

Input:
Set of AR (association rule technique) generated Rules: γ. The set of rules is sorted in decreasing order of support of its constituent rules.
‘λ’ (<<|γ|) as in Top-λ window containing top λ rules visible to a developer
‘ε’ i.e. support band within which rules will be considered to have same ‘extended support’ value (e.g., sufficiently close support).

Output:
Revised set (γₙᵣ) of non-redundant rules. Pick top λ from this list to fill Top-λ window.

Acts:

```
    1. begin
    2. define γₙᵣ and initialize γₙᵣ← Φ (null set)
    3. Cluster γ given ε based on clustering technique (e.g., Example 41).
    4. for each rule rεγ
        a. convert ‘r’ to its extended representation (e.g., Example 33) by inserting
‘any’ value for every missing attribute, AεΩ and A∉ r
        b. r.status ← ‘In’
    5. for each ( rᵢεγ, i ε [1, |γ| )
        a. if (rᵢ.status == ‘Out’) skip rest and start next iteration [i-loop];
        b. for each ( rⱼεγ, j=i+1 & j<|γ| )
            i. if (rⱼ.status == “Out”) skip the rest and start next iteration [j-loop];
            ii. check if (r_{i,} rⱼ) is either:
                independent (e.g., Examples 34 and 35).
                    If so, γₙᵣ ← γₙᵣU{r_{i,} rⱼ}.
                    rᵢ.status ← ‘In’;
                    rⱼ.status ← ‘In’;
            redundant (e.g., Examples 34 and 35).
                If (rᵢ is redundant) { rᵢ .status← ‘Out’; rⱼ .status← ‘In’; γₙᵣ ← γₙᵣ
U {rⱼ}}
                otherwise { rⱼ .status←‘Out’; rᵢ .status←‘In’; γₙᵣ ← γₙᵣ U {rᵢ}}
        c. end for (j-loop)
    6. end for (i-loop)
    7. ‘γₙᵣ’ contains independent rules ordered in descending support of the rules.
Alternatively, γ contains rules whose ‘status’ filled has been marked as ‘In’ or ‘Out’ and is as
useful as ‘γₙᵣ’.
    8. End
```

### Example 43

### Exemplary Domain-Specific Changes to the ε-Extended Technique

One can refine rules further through domain specific knowledge. In an application store, for example, one can check if only ‘state’ attribute is present without ‘country’ in a rule. In that case, retrieve country information given the state information from a stored look up table. There can be many such refinements possible which can be done before rules are subjected to redundancy elimination.

### Example 44

### Exemplary Improvement to Above Technique

In the ε-extended algorithm above, clustering can be applied regardless of the set-subset relationship between rules. Consider a set of rules i.e. γ={R₁, R₂, R₃, R₄} where {R₁,R₂} are dependent and the rest are not. Assume that the rules are equidistant with respect to their support and the difference between their support is (ε−δ) where δ<<ε. When one performs nearest neighbor clustering on γ, the set of clusters generated by the technique will be [{R₁}, {R₂}, {R₃,R₄}]. Since {R₃,R₄} are independent by assumption, the reduced set of rules (γₙᵣ) will be the same as γ.

However, one could have reduced {R₁,R₂} first, as they are within ε-distance for sure. So, the accuracy of the proposed algorithm clearly suffered for such corner cases.

To improve accuracy even for corner cases, one can do the following:

A. Run the set-subset identification algorithm on the rule set, γ. This will generate a list, Υ={γ₁, . . . , γₖ} of rule sets.

γᵢ (i^{th} rule list, i=1 . . . k) contains rules which are related through a containment relationship.

Rules within γᵢ are ordered with their support in descending order from more general to very specific.

B. For each γᵢ (i^{th} rule list, i=1 . . . k), apply the technique implementing the ε-extended support bands given ε and γᵢ. For efficiency of speed, one may skip the set-subset determination step since the rules in γᵢ are known to possess set-subset relationship. Here redundant rules are marked as “out’ as before.

C. Now generate non redundant rule set, γₙᵣ, by including from γ for all rules having status marked as “in”.

D. Stop

For the exceptional case as cited above, and following the revised algorithm above, Step-a will split γ into Υ=({R₁}, {R₂}, {R₃,R₄}) and apply Step-b for each of the lists. Given that {R₃,R₄} are within ε-neighborhood, this list will be reduced. The set of non-redundant rules identified will now be more exhaustive.

### Example 45

### Exemplary Selection of ε

In the ε-extended algorithm above, clustering will be influenced by the choice of the parameter, ‘ε’.

As is evident for AR algorithm, the support of patterns (related through set-subset) stay close to each other until it drops sharply beyond a threshold length of the patterns. This means redundant rules are clustered VERY closely and the separation increases drastically thereafter. Hence a small value of ‘ε’ will suffice for the purpose of clustering.

ε can be a function of the total number of transactions (N) of the entire rule set, γ, i.e. ε(N). Hence, one can create a table that captures observed relationship between ‘c’ and N, for example, as follows.

| N | ε |
|---|---|
| [0-99] | .02 |
| [100-999] | .0175 |
| [1000-9999] | .015 |
| [10000-99999] | .01 |
| [100000-above] | .005 |

One can choose ε=0.01 i.e. 1% uniformly or it can be chosen from the table above. Or, the parameter can be configurable by a user.

### Example 46

### Exemplary Performance

Various experiments on various data (discovered rules) sets were run to measure the performance of the stated metrics (See the metrics for performance described herein). A data set has various AR models for each of the constituent minable elements e.g. ‘App’s, ‘Category’-s, ‘Sub-Category’-s etc. Two sets of real world data were used, including one from an application store and two synthetic data sets for benchmarking performance of the techniques for redundancy elimination.

The table below captures the performance data for the aforesaid metrics for <μ=0.03, ε=0.01, N=5>. Across various data sets over their constituent models, it has improved 87.8% of the models. If one focuses only on real world data, 95% of the considered models resulted in redundancy elimination, which is clearly an indication of the technique's effectiveness.

In the below examples, μ<0.03, ε=0.02, and N=5. Epsilon filtering was done first, and the applied containment relationship was applied next. Alternatively, the list of contained rules can be first created, followed by ε support clustering, resulting in even higher redundancy removal metrics.

| | Code | | | | | Min | % Models |
|---|---|---|---|---|---|---|---|
| | (Data | | % KO | % CG | % RE | Support | with KO |
| Data Set | Set) | #Models | Avg | Avg | Avg | (μ) | (>0%) |
| Synthetic Data: No | A | 23 | 26.08 | 26.08 | 12.37 | .03 | 100 |
| Attributes are uni- | | | | | | | |
| valued | | | | | | | |
| Synthetic Data: | B | 25 | 15.2 | 20.00 | 22.71 | .03 | 60 |
| Gender Attribute is uni- | | | | | | | |
| valued | | | | | | | |
| Real World: | C | 52 | 40.38 | 57.3 | 28.28 | .03 | 100 |
| Application Store | | | | | | | |
| internal Environment | | | | | | | |
| (Country is uni-valued) | | | | | | | |
| Real World: Another | D | 7 | 44.57 | 36.64 | 43.73 | .03 | 57.14 |
| data set (Gender is uni- | | | | | | | |
| valued) | | | | | | | |
| OVERALL | | 107 | | | | | 87.8 |

The detailed performance data for each of the above data sets have been plotted by varying Min Support (μ), Epsilon (ε).

Models have been categorized based on number of rules they contain into 6 ranges [Range1: 1-10, Range2: 11-20, Range3: 21-30, Range4: 31-40, Range5: 41-50, Range6: >50].

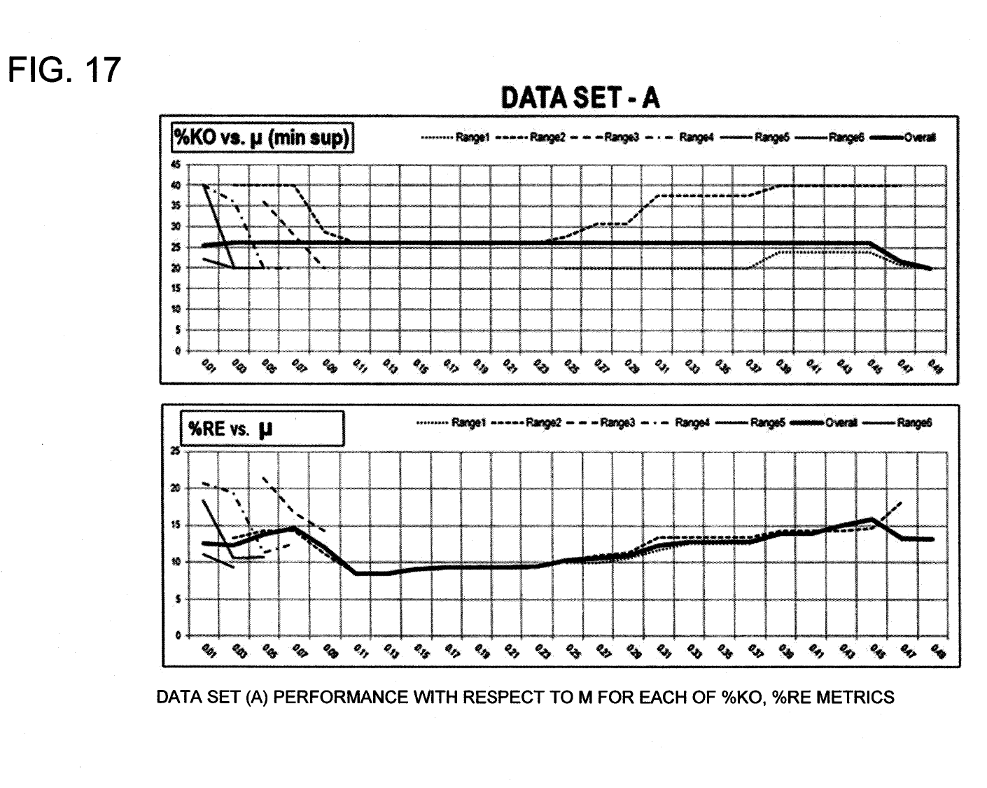

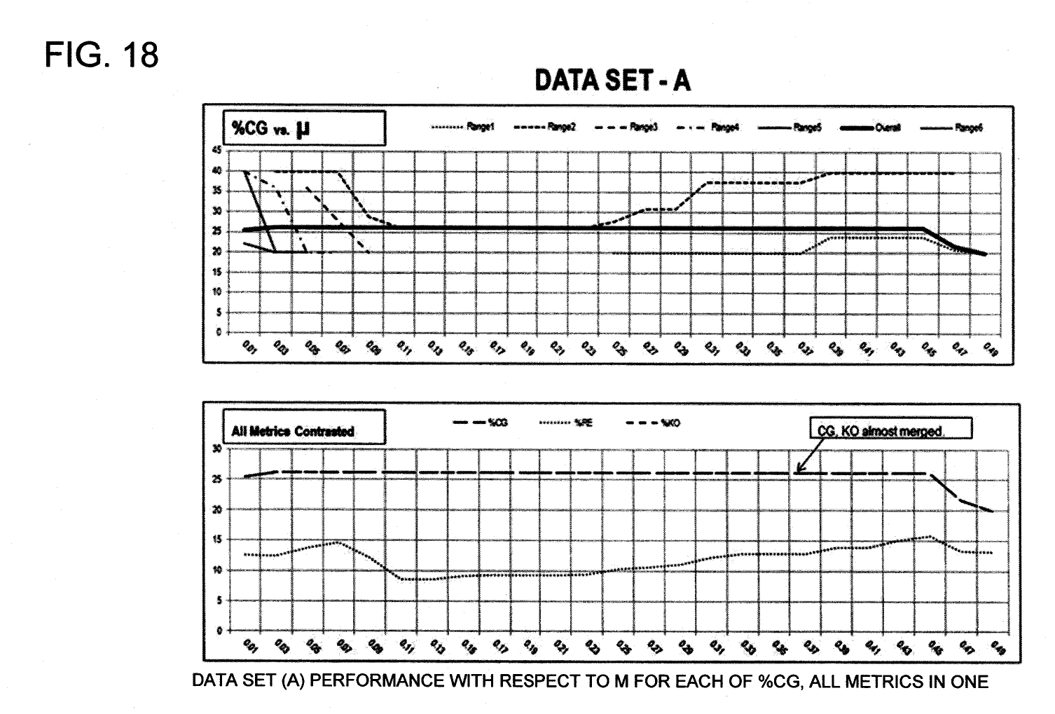

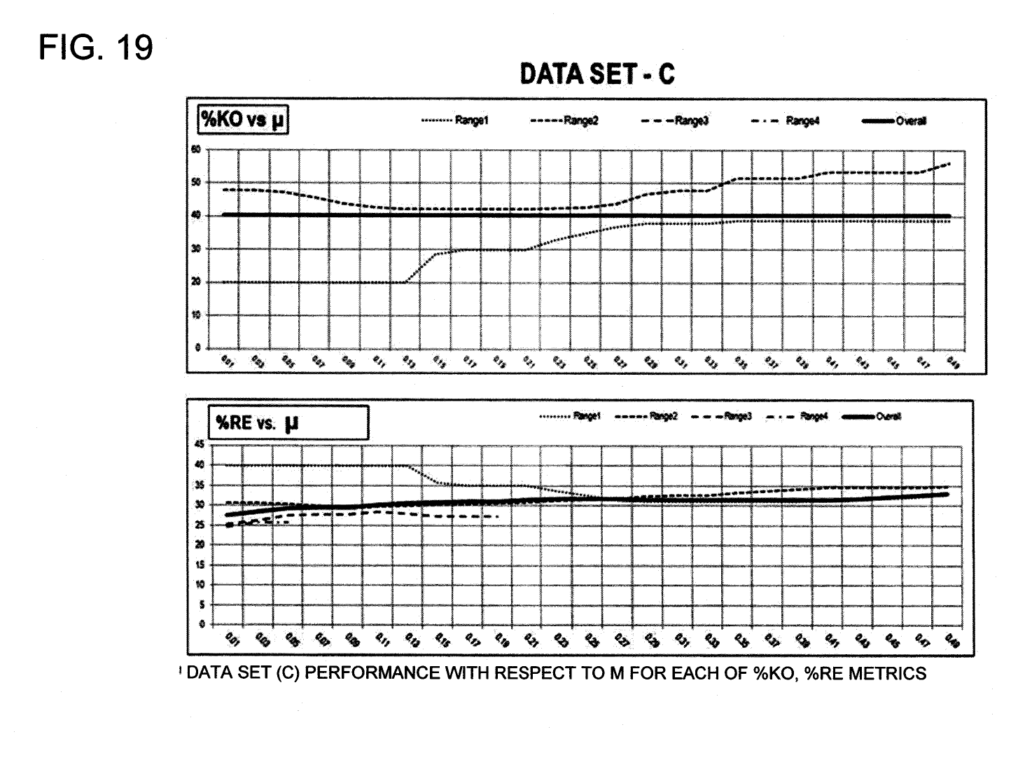

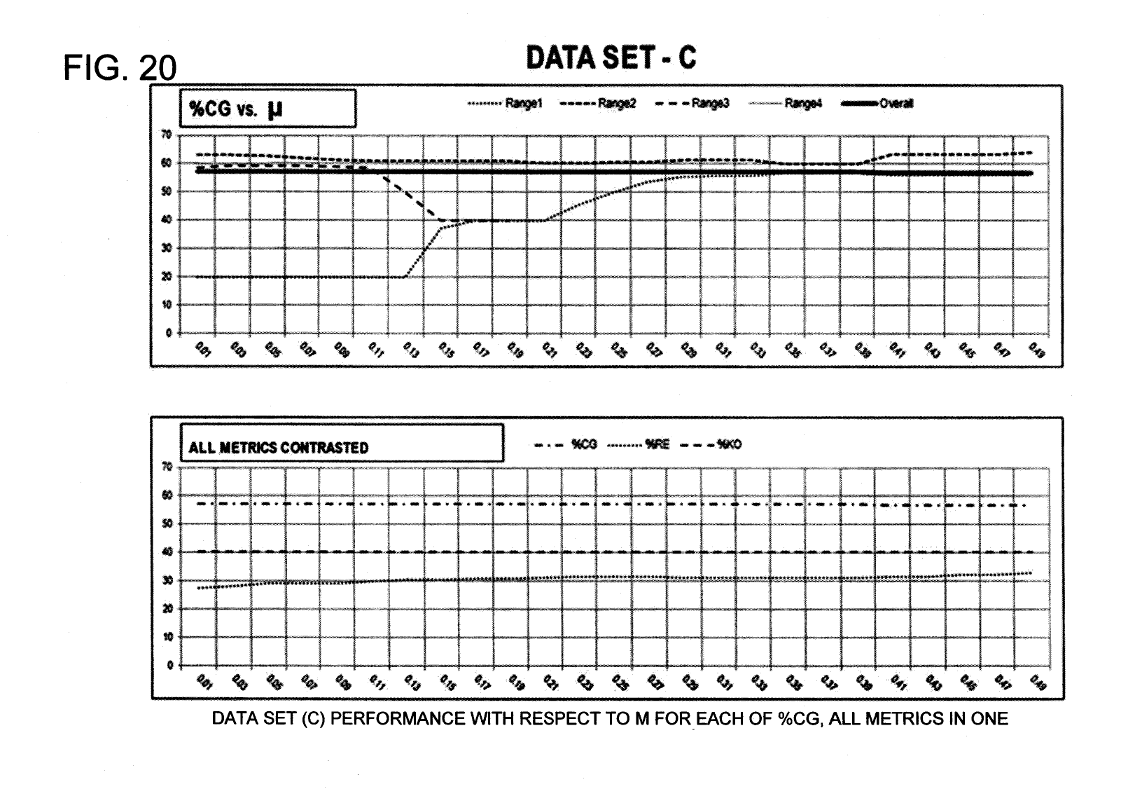

Detailed performance graphs are ordered as % KO, % RE, % CG and All In One for each data set. Detailed graphs for Data Set—A (Synthetic), Performance Graphs for Data Set—C (Real World) are available in the drawings. FIGS. 17, 18, 19, and 20 are graphs showing data set performance.

### Example 47

### Exemplary Computing Systems

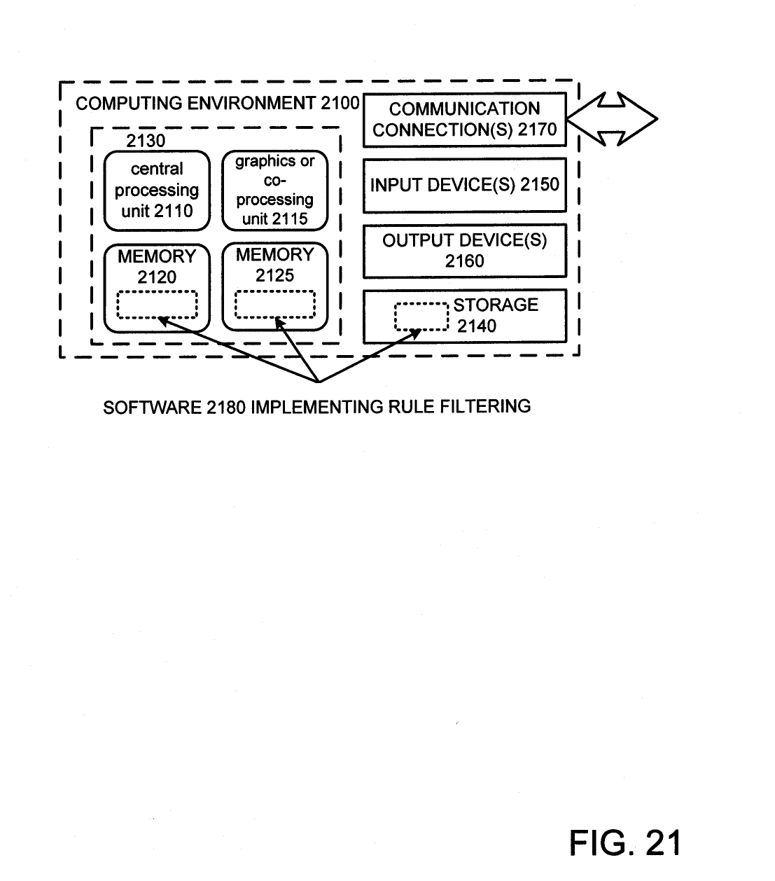

FIG. 21 illustrates a generalized example of a suitable computing system 2100 in which several of the described innovations may be implemented. The computing system 2100 is not intended to suggest any limitation as to scope of use or functionality, as the innovations may be implemented in diverse general-purpose or special-purpose computing systems.

With reference to FIG. 21, the computing system 2100 includes one or more processing units 2110, 2115 and memory 2120, 2125. In FIG. 21, this basic configuration 2130 is included within a dashed line. The processing units 2110, 2115 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 21 shows a central processing unit 2110 as well as a graphics processing unit or co-processing unit 2115. The tangible memory 2120, 2125 may be volatile memory (e.g., registers, cache, RAM), non-volatile memory (e.g., ROM, EEPROM, flash memory, etc.), or some combination of the two, accessible by the processing unit(s). The memory 2120, 2125 stores software 2180 implementing one or more innovations for consumer transaction redundancy filtering, in the form of computer-executable instructions suitable for execution by the processing unit(s).

A computing system may have additional features. For example, the computing system 2100 includes storage 2140, one or more input devices 2150, one or more output devices 2160, and one or more communication connections 2170. An interconnection mechanism (not shown) such as a bus, controller, or network interconnects the components of the computing system 2100. Typically, operating system software (not shown) provides an operating environment for other software executing in the computing system 2100, and coordinates activities of the components of the computing system 2100.

The tangible storage 2140 may be removable or non-removable, and includes magnetic disks, magnetic tapes or cassettes, CD-ROMs, DVDs, or any other medium which can be used to store information in a non-transitory way and which can be accessed within the computing system 2100. The storage 2140 stores instructions for the software 2180 implementing one or more innovations for consumer transaction rule redundancy filtering.

The input device(s) 2150 may be a touch input device such as a keyboard, mouse, pen, or trackball, a voice input device, a scanning device, or another device that provides input to the computing system 2100. For video encoding, the input device(s) 2150 may be a camera, video card, TV tuner card, or similar device that accepts video input in analog or digital form, or a CD-ROM or CD-RW that reads video samples into the computing system 2100. The output device(s) 2160 may be a display, printer, speaker, CD-writer, or another device that provides output from the computing system 2100.

The communication connection(s) 2170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computing system 2100, computer-readable media include memory 2120, 2125, storage 2140, and combinations of any of the above.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 48

### Exemplary Mobile Device

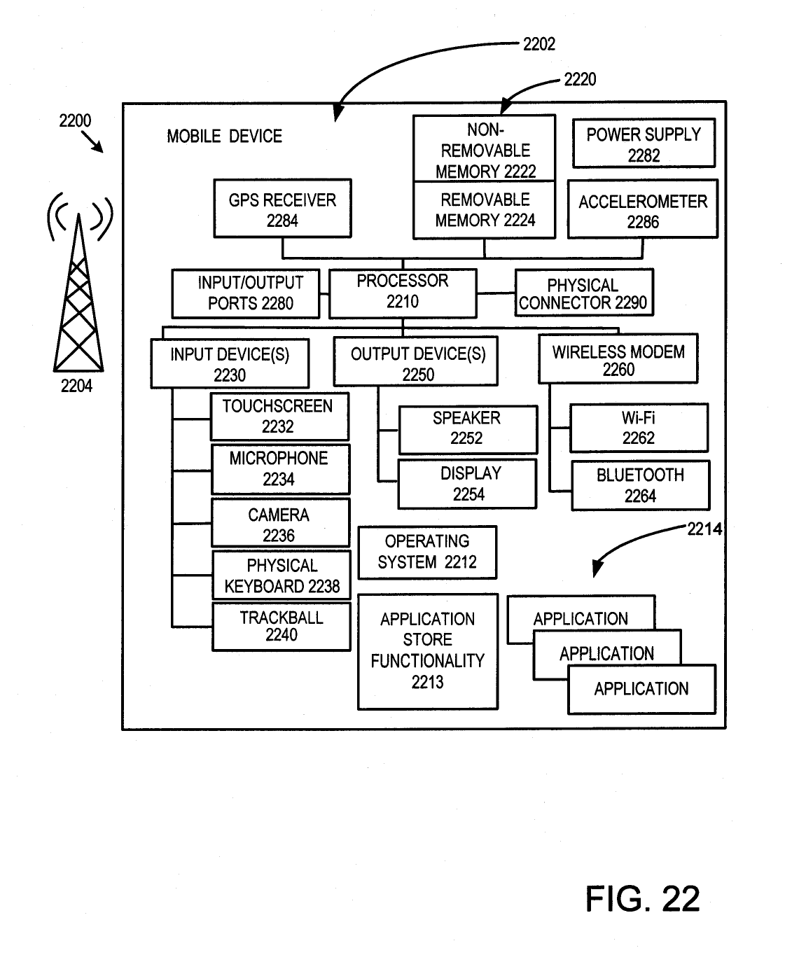

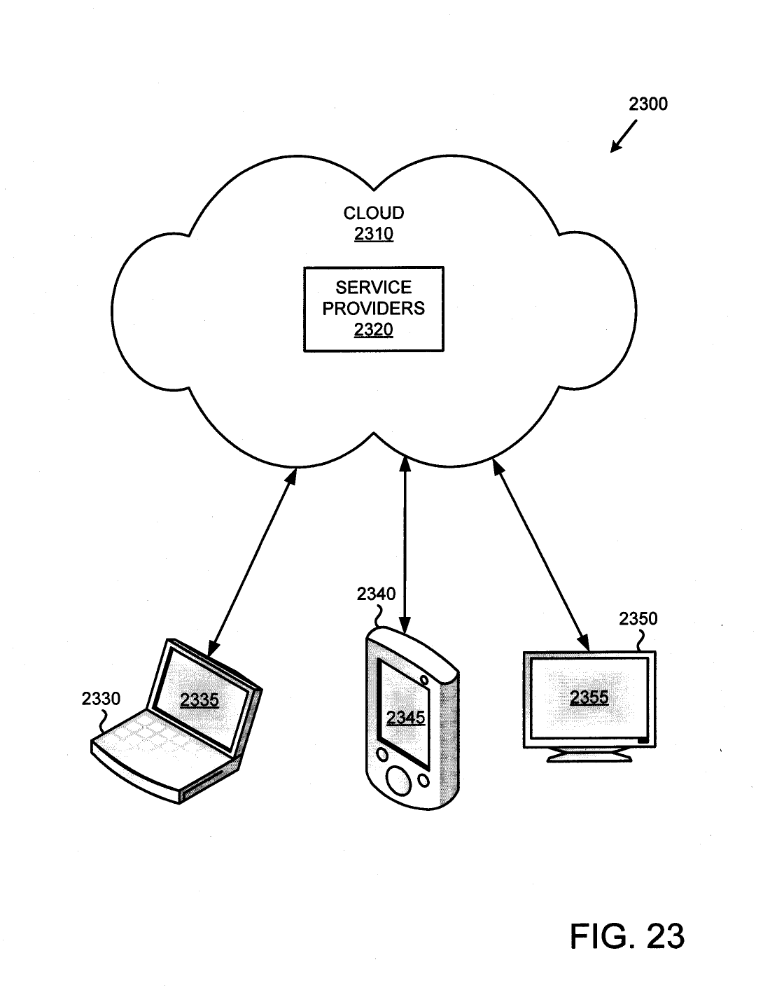

FIG. 22 is a system diagram depicting an exemplary mobile device 2200 including a variety of optional hardware and software components, shown generally at 2202. Any components 2202 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 2204, such as a cellular, satellite, or other network.

The illustrated mobile device 2200 can include a controller or processor 2210 (e.g., signal processor, microprocessor, ASIC, or other control and processing logic circuitry) for performing such tasks as signal coding, data processing, input/output processing, power control, and/or other functions. An operating system 2212 can control the allocation and usage of the components 2202 and support for one or more application programs 2214. The application programs can include common mobile computing applications (e.g., email applications, calendars, contact managers, web browsers, messaging applications), or any other computing application. Functionality 2213 for accessing an application store can also be used for acquiring and updating applications 2214.

The illustrated mobile device 2200 can include memory 2220. Memory 2220 can include non-removable memory 2222 and/or removable memory 2224. The non-removable memory 2222 can include RAM, ROM, flash memory, a hard disk, or other well-known memory storage technologies. The removable memory 2224 can include flash memory or a Subscriber Identity Module (SIM) card, which is well known in GSM communication systems, or other well-known memory storage technologies, such as “smart cards.” The memory 2220 can be used for storing data and/or code for running the operating system 2212 and the applications 2214. Example data can include web pages, text, images, sound files, video data, or other data sets to be sent to and/or received from one or more network servers or other devices via one or more wired or wireless networks. The memory 2220 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 2200 can support one or more input devices 2230, such as a touch screen 2232, microphone 2234, camera 2236, physical keyboard 2238 and/or trackball 2240 and one or more output devices 2250, such as a speaker 2252 and a display 2254. Other possible output devices (not shown) can include piezoelectric or other haptic output devices. Some devices can serve more than one input/output function. For example, touchscreen 2232 and display 2254 can be combined in a single input/output device.

A wireless modem 2260 can be coupled to an antenna (not shown) and can support two-way communications between the processor 2210 and external devices, as is well understood in the art. The modem 2260 is shown generically and can include a cellular modem for communicating with the mobile communication network 2204 and/or other radio-based modems (e.g., Bluetooth or Wi-Fi). The wireless modem 2260 is typically configured for communication with one or more cellular networks, such as a GSM network for data and voice communications within a single cellular network, between cellular networks, or between the mobile device and a public switched telephone network (PSTN).

The mobile device can further include at least one input/output port 2280, a power supply 2282, a satellite navigation system receiver 2284, such as a Global Positioning System (GPS) receiver, an accelerometer 2286, and/or a physical connector 2290, which can be a USB port, IEEE 1394 (FireWire) port, and/or RS-232 port. The illustrated components 2202 are not required or all-inclusive, as any components can deleted and other components can be added.

### Example 49

### Exemplary Cloud-Supported Environment

In example environment 2300, the cloud 2310 provides services for connected devices 2330, 2340, 2350 with a variety of screen capabilities. Connected device 2330 represents a device with a computer screen 2335 (e.g., a mid-size screen). For example, connected device 2330 could be a personal computer such as desktop computer, laptop, notebook, netbook, or the like. Connected device 2340 represents a device with a mobile device screen 2345 (e.g., a small size screen). For example, connected device 2340 could be a mobile phone, smart phone, personal digital assistant, tablet computer, and the like. Connected device 2350 represents a device with a large screen 2355. For example, connected device 2350 could be a television screen (e.g., a smart television) or another device connected to a television (e.g., a set-top box or gaming console) or the like. One or more of the connected devices 2330, 2340, 2350 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 2300. For example, the cloud 2310 can provide services for one or more computers (e.g., server computers) without displays.

Services can be provided by the cloud 2310 through service providers 2320, or through other providers of online services (not depicted). For example, cloud services can be customized to the screen size, display capability, and/or touch screen capability of a particular connected device (e.g., connected devices 2330, 2340, 2350).

In example environment 2300, the cloud 2310 provides the technologies and solutions described herein to the various connected devices 2330, 2340, 2350 using, at least in part, the service providers 2320. For example, the service providers 2320 can provide a centralized solution for various cloud-based services. The service providers 2320 can manage service subscriptions for users and/or devices (e.g., for the connected devices 2330, 2340, 2350 and/or their respective users).

### Example 50

### Exemplary Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

### Non-Transitory Computer-Readable Media

Any of the computer-readable media herein can be non-transitory (e.g., memory, magnetic storage, optical storage, or the like).

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

1. A method implemented at least in part by a computer, the method comprising:
receiving a plurality of candidate consumer transaction rule entries, wherein the candidate consumer transaction rule entries comprise rules indicating respective support ratings for occurrences of like consumer characteristic values associated with application store consumer transactions;
identifying at least one of the candidate consumer transaction rule entries as redundant, wherein the identifying comprises determining that support ratings for two of the candidate consumer transaction rule entries are sufficiently close and identifying a containment relationship between the two of the candidate consumer transaction rule entries; and
filtering the candidate consumer transaction rule entries, wherein the filtering comprises removing the at least one of the redundant candidate consumer transaction rule entries.

2. One or more computer-readable storage devices comprising computer-executable instructions for performing the method of claim 1.

3. The method of claim 1, wherein filtering the candidate consumer transaction rule entries generates filtered rule entries, the method further comprising:
displaying the filtered rule entries in a user interface.

4. The method of claim 3, further comprising:
ranking the filtered rule entries by support rating;
wherein the displaying displays a top A rule entries as ranked by support rating.

5. The method of claim 1, wherein:
determining that the support ratings are sufficiently close is performed after identifying a containment relationship.

6. The method of claim 1, wherein:
determining that support ratings for two of the candidate consumer transaction rule entries are sufficiently close comprises clustering the candidate consumer transaction rule entries into support bands according to a support threshold E.

7. The method of claim 6, wherein:
the clustering clusters at least one of the candidate consumer transaction rule entries in a support band with an other of the candidate consumer transaction rule entries having a different support rating.

8. The method of claim 1 further comprising:
refining the candidate consumer transaction rule entries based on domain-specific heuristics.

9. The method of claim 1, wherein the consumer characteristic values are represented in the candidate consumer transaction rule entries as attribute-value pairs.

10. The method of claim 1, further comprising:
indicating a value of any for one or more consumer characteristic values not present in a first candidate consumer transaction rule entry but present in an other candidate consumer transaction rule entry.

11. The method of claim 1, wherein identifying a containment relationship comprises:
generating a bit vector pair for a respective pair of the candidate consumer transaction rule entries based on comparison of individual consumer characteristic values in the pair of the candidate consumer transaction rule entries.

12. The method of claim 11 further comprising:
evaluating the bit vector pair for the pair of the candidate consumer transaction rule entries.

13. The method of claim 12 wherein the evaluating comprises:
performing a logical and operation on the bit vector pair to produce a result; and
comparing the result to bit vectors in the bit vector pair.

14. The method of claim 1, wherein the method further comprises:
calculating a redundancy elimination metric comprising calculating:
(candidate consumer transaction rule entries identified as redundant) divided by (total number of candidate consumer transaction rule entries).

15. The method of claim 1, wherein the method further comprises:
for a top N window of filtered rule entries ranked by support rating, determining a ranking, L, of a Nth rule entry in the candidate consumer transaction rule entries; and
calculating a coverage gain metric comprising calculating:
(L divided by N)−1.

16. The method of claim 1, wherein the method further comprises:
for a top N window of candidate consumer transaction rule entries, determining a number of candidate consumer transaction rule entries filtered R as redundant; and
calculating a knocked off metric comprising calculating R divided by N.

17. (canceled)

18. (canceled)

19. (canceled)

20. (canceled)

21. One or more computer-readable storage devices comprising computer-executable instructions for performing a method comprising:
receiving a plurality of application store consumer transaction rule entries indicative of occurrences of consumer characteristics for consumers downloading a particular application from an application store;
responsive to identifying that a plurality of the application store consumer transaction rule entries have a containment relationship, placing the plurality of the application store consumer transaction rule entries having the containment relationship into a group of application store consumer transaction rule entries;
responsive to determining that support ratings for a pair of rule entries in the group of application store consumer transaction rule entries are within a threshold c, identifying one of the rule entries of the pair as redundant;
filtering the application store consumer transaction rules entries, wherein filtering comprises removing the rule entry identified as redundant; and
displaying the filtered application store consumer transaction rule entries and associated consumer characteristics in an order ranked by support rating.

22. One or more computer-readable storage devices comprising computer-executable instructions for performing a method comprising:
receiving a plurality of candidate consumer transaction rule entries, wherein the candidate consumer transaction rule entries comprise rules indicating respective support ratings for occurrences of like consumer characteristic values associated with application store consumer transactions;
identifying at least one of the candidate consumer transaction rule entries as redundant, wherein the identifying comprises determining that support ratings for two of the candidate consumer transaction rule entries are sufficiently close and identifying a containment relationship between the two of the candidate consumer transaction rule entries; and
filtering the candidate consumer transaction rule entries, wherein the filtering comprises removing the at least one of the redundant candidate consumer transaction rule entries.
